(19) United States
(12) Patent Application Publication
(10) Pub. No.: US 2018/0232707 A1
(43) Pub. Date: Aug. 16, 2018

(54) VEHICLE MAINTENANCE SCHEDULING SYSTEMS AND METHODS

(71) Applicant: AEROSTRAT CORPORATION, Seattle, WA (US)

(72) Inventors: Frankie ANGAI, Los Angeles, CA (US); Elliot MARGUL, Issaquah, WA (US); Cody MORRIS, Dallas, TX (US)

(21) Appl. No.: 15/430,271

(22) Filed: Feb. 10, 2017

(51) Int. Cl. G06Q 10/00; G06Q 10/10

(52) U.S. Cl. CPC G06Q 10/20; G06Q 10/1095

(57) ABSTRACT

Methods and systems are presented for coordinating complex maintenance tasks needed by multiple vehicles (aircraft, e.g.) at heterogeneous facilities across multiple months. Several kinds of compatibility are confirmed in an automatically generated preliminary schedule that takes into account one or more target yields for each taskset and one or more shared tiers of prioritization. A resulting schedule is finalized and disseminated quickly after any updates to an input dataset so that rescheduling opportunities not previously possible are manifested at scale.

### FIELD

This disclosure relates to coordinating complex maintenance tasks needed by multiple vehicles (aircraft, e.g.) at heterogeneous facilities across multiple months.

### BACKGROUND

Larger mechanisms that transport freight or passengers require complex, specialized maintenance of various types on a regular basis. Standards have emerged in respective industries to implement pooled vehicle maintenance tasksets across multiple vehicles, sometimes planned by a group of specialists (a fleet maintenance department, e.g.). In aircraft maintenance, for example, there is a class of tasksets known as “letter checks.” An “A-Check,” for example, is typically performed every 2-6 weeks and it generally includes an inspection of the interior and exterior of an aircraft with selected areas opened. A-check tasks may also include lubrication, operational checks, verifying fluid levels, filter replacement, and various other inspections. A “D-Check” is a taskset, typically performed every 4-12 years, that may include uncovering the airframe, supporting structure and wings for inspection of structurally significant items; repairing/overhauling/exchanging internal components; completion of extensive modifications to the aircraft such that of installing new fuel storage systems and/or installation of new avionics.

In recent years the Maintenance Steering Group published a new philosophy and guidelines for maintenance programs known as “MSG-3.” MSG-3 differed in approached to the prior program (MSG-2) in that the maintenance philosophy changed from a bottom-up to a top-down approach when designing maintenance programs and scheduling vehicle maintenance. These philosophies have complicated the long term planning and scheduling of maintenance needs as further maintenance requirements are necessitated by the more detailed top-down approach. Although ad hoc or basic manual maintenance have started to give way to programmatic scheduling, none of the currently available tools or practices allow for any substantial adjustment or timely dissemination of changes when some members of a scheduling team are offline.

### BRIEF DESCRIPTION OF THE DRAWINGS

FIG. 1 illustrates an exemplary system in which various facilities are preparing to perform maintenance tasks upon various vehicles.

FIG. 2 illustrates yield goals in relation to a plurality of tasks to be performed upon a plurality of vehicles.

FIG. 3 illustrates an exemplary taskset list signaling upcoming tasksets to be performed upon a plurality of vehicles.

FIG. 4 illustrates facility-to-vehicle tabular compatibility data residing on one or more storage media.

FIG. 5 illustrates taskset-to-taskset tabular compatibility data residing on one or more storage media.

FIG. 6 illustrates facility-to-taskset tabular compatibility data residing on one or more storage media.

FIG. 7 illustrates an exemplary client device suitable for use with one or more embodiments.

FIG. 8 illustrates an exemplary server suitable for use with one or more embodiments.

FIG. 9 illustrates an exemplary data flow suitable for use with one or more embodiments.

FIG. 10 illustrates exemplary event-sequencing logic suitable for use with one or more embodiments.

FIG. 11 illustrates an image that can be presented on a single display screen signifying one or more expressions of a maintenance schedule being built.

FIG. 12 illustrates another image like that of FIG. 11, but further along.

FIG. 13 illustrates part of a scheduling routine suitable for use with one or more embodiments.

FIG. 14 illustrates a continuation of the scheduling routine of FIG. 13.

FIG. 15 illustrates another exemplary taskset list signaling upcoming tasksets to be performed upon a plurality of vehicles.

FIG. 16 illustrates an image that can be presented on a single display screen signifying one or more expressions of a maintenance schedule being built.

FIG. 17 illustrates another image like that of FIG. 16, but further along.

FIG. 18 illustrates a scheduling subroutine suitable for use with one or more embodiments.

FIG. 19 illustrates part of a scheduling subroutine suitable for use with one or more embodiments.

FIG. 20 illustrates a continuation of the scheduling subroutine of FIG. 19.

FIG. 21 illustrates part of a scheduling subroutine suitable for use with one or more embodiments.

FIG. 22 illustrates a continuation of the scheduling subroutine of FIG. 21.

FIG. 23 illustrates a scheduling subroutine suitable for use with one or more embodiments.

FIG. 24 illustrates a scheduling subroutine suitable for use with one or more embodiments.

FIG. 25 illustrates part of a scheduling subroutine suitable for use with one or more embodiments.

FIG. 26 illustrates a continuation of the scheduling subroutine of FIG. 25.

### RELATED APPLICATIONS

None

### DETAILED DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote database servers, computer servers and memory storage devices.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“At least,” “automatic,” “better,” “between,” “compatible,” “complete,” “conditional,” “current,” “existing,” “false,” “first,” “having,” “higher,” “in,” “incompatible,” “intermediate,” “internal,” “lower,” “maximum,” “minimum,” “new,” “on,” “other,” “overlapping,” “responsive,” “scheduled,” “second,” “standalone,” “successful,” “target,” “tentative,” “third,” “true,” “with,” or other such descriptors herein are used in their normal yes-or-no sense, not as terms of degree, unless context dictates otherwise. In light of the present disclosure those skilled in the art will understand from context what is meant by “remote” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures. As used herein, the term “contemporaneous” refers to circumstances or events that are concurrent or at least roughly contemporaneous (on the same day, e.g.).

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

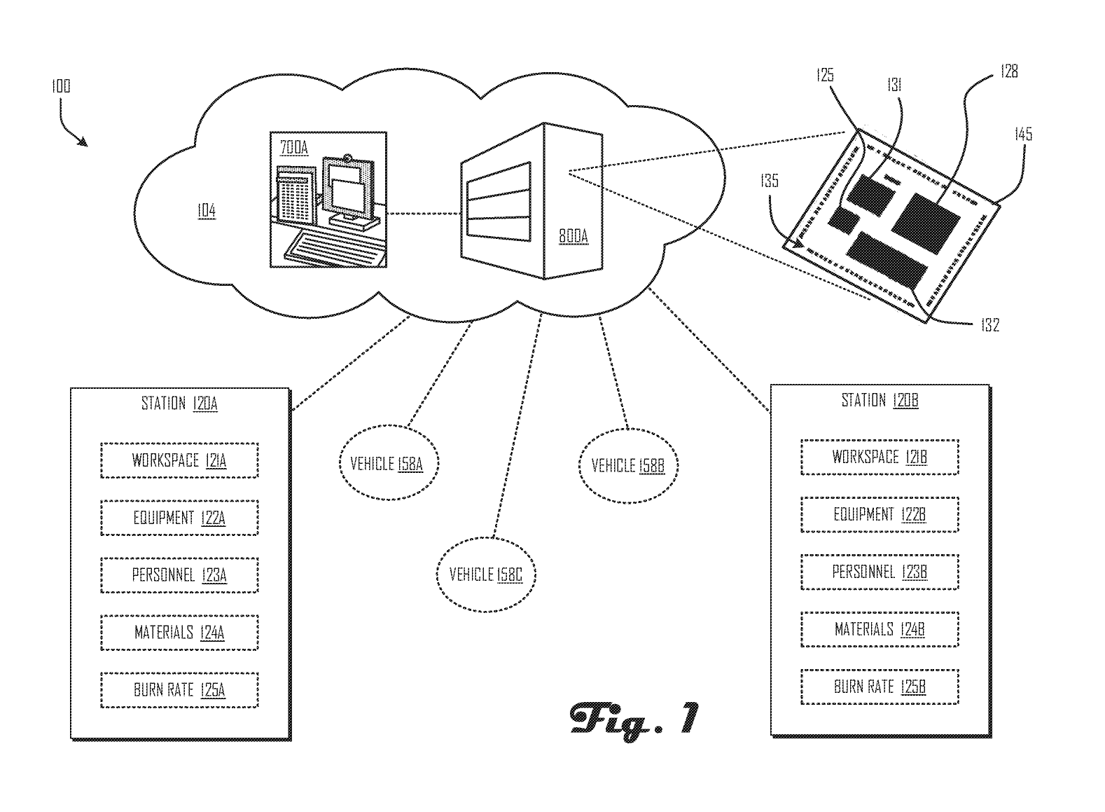

FIG. 1 depicts a system 100 in which one or more technologies may be implemented. A server 800A implements various intelligence amplification protocols as described below. System 100 is tailored to streamline various computer processes, especially data input and retention, to facilitate successful maintenance scheduling projects at scale. One or more users of client device 700A within network 104 receive reminders from one or more servers 800, which is also operably coupled to one or more other client devices 700 implementing (within or otherwise associated with) two or more vehicles 158A-C and a plurality of facilities/stations 120A-B. Each such station may include one or more instances of specialized workspaces 121A-B. Each such workspace (bay or berth, e.g.) is configured specifically to receive/contain a single vehicle 158 while allowing physical contact between the vehicle 158 and one or more instances of specialized equipment 122A-B (toolkits, e.g.), of specialized materials 123A-B (components, e.g.), or of specialized personnel 124A-B (or a combination thereof) so as to define a composite respective burn rate 125A-B that is for scheduling purposes sufficient to establish how long two or more compatible tasksets (having a mutual synergy, e.g.) will require when performed concurrently upon a given type of vehicle.

Each server 800 may likewise include an integrated circuit 145 (an Application-Specific Integrated Circuit, e.g.) having one or more instances of special-purpose modules 125, 128; one or more memories 131, 132, and numerous bonding pads 135 (each an example of an electrical node as described herein) by which communicative and other electrical coupling is made (to other modules within server 800, e.g.). In some contexts, one or more stations 120 or other client devices 700. Alternatively or additionally, some such client devices 700 may each be associated with a respective vehicle 158 (by virtue of being aboard, e.g.).

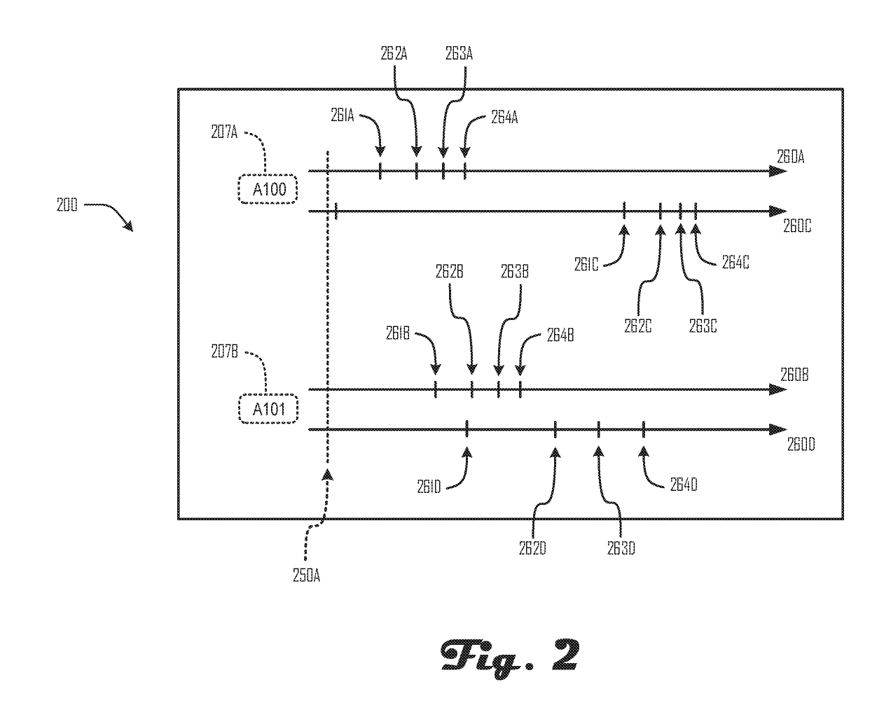

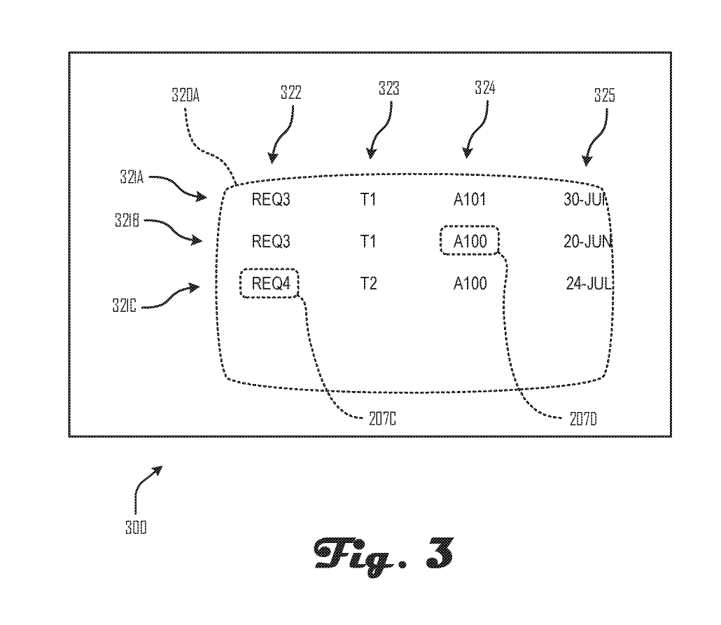

FIG. 2 presents components of potential goals/yields or other expressions as an image 200 (displayed via display hardware of a vehicle 158 or other client device 700, e.g.) of respective timelines 260A-D each corresponding to a prospective performance of a taskset upon a vehicle 158. Relative to a current time marker 250A, several potential yields 261A, 262A, 263A are presented all in relation to a completion deadline 264A (signifying a yield of 100%) for a particular taskset (identified as “REQ3” in FIGS. 3, 6, and 15 below, e.g.) that must soon be performed upon a particular vehicle 158 (identified as “A100” in FIGS. 3-4 and 15-17 below, e.g.) at a single facility/station 120 selected from among a plurality available to a fleet. Several potential yields 261B, 262B, 263B are likewise all presented in relation to a completion deadline 264B for a (nominally) identical taskset (likewise identified as “REQ3” in FIGS. 3, 6, and 15 below, e.g.) to be performed upon another vehicle 158 (identified as “A101,” e.g.) at (either the same or a different) single facility/station 120 selected from among the plurality. Several potential yields 261C, 262C, 263C are likewise all presented in relation to a completion deadline 264C for a different taskset (identified as “REQ1” below, e.g.) to be performed upon the first-mentioned vehicle (identified as “A100” by an alphanumeric label 207A as shown, e.g.) at (either the same or a different) single facility/station 120 selected from among the plurality. Several potential yields 261D, 262D, 263D are likewise all presented in relation to a completion deadline 264D for a different taskset (identified as “REQ2” below, e.g.) to be performed upon the second-mentioned vehicle (identified as “A101” by an alphanumeric label 207B as shown, e.g.) at (either the same or a different) single facility/station 120 selected from among the plurality. In each instance as shown the primary target yield 262A-D is (1) roughly midway (i.e. in the middle half of the time interval) between each corresponding minimum and maximum yield 261, 263 or (2) in a latter half of the time interval between each corresponding minimum and maximum yield 261, 263 (or both).

FIG. 3 depicts a taskset list 320A comprising several records 321A-C all stored on one or more non-transitory media 300. As shown each such record includes a taskset identifier 322 respectively associated with a criticality-indicative category 323, a vehicle identifier 324, and a completion deadline 325 (each comprising one or more scalars or alphanumeric labels, e.g.). For example, alphanumeric label 207C designates a taskset identified as “REQ4” and alphanumeric label 207D that identifies a vehicle 158 (as “A100”) upon which tasksets “REQ3” and “REQ4” should be done, each while accounting for compatibilities and other constraints as described below. Criticality-indicative categories 323 (or “tiers”) as used herein refer to a value or range of values (expressible as a scalar like “2” or other alphanumeric expression, e.g.) at least one of which likens two or more listed tasksets in importance. This can occur, for example, in a context in which a scheduling specialist thus manifests an indifference to reordering that is sufficiently substantial as to invite an automated or semi-automated exploration of possible advantages among the permutations of task processing resequencing even while maintaining a degree of coarse prioritization so as to manifest a preference that scheduling flaws or failures occur among lower-priority tasksets rather than higher-priority tasksets. Because of the meaningful advances presented herein over prior technologies, it will now be possible for a single human scheduling specialist to coordinate such heavy maintenance requirements for a fleet of many vehicles (i.e. more than ten) over a substantial period (i.e. more than a year) optimally and reliably.

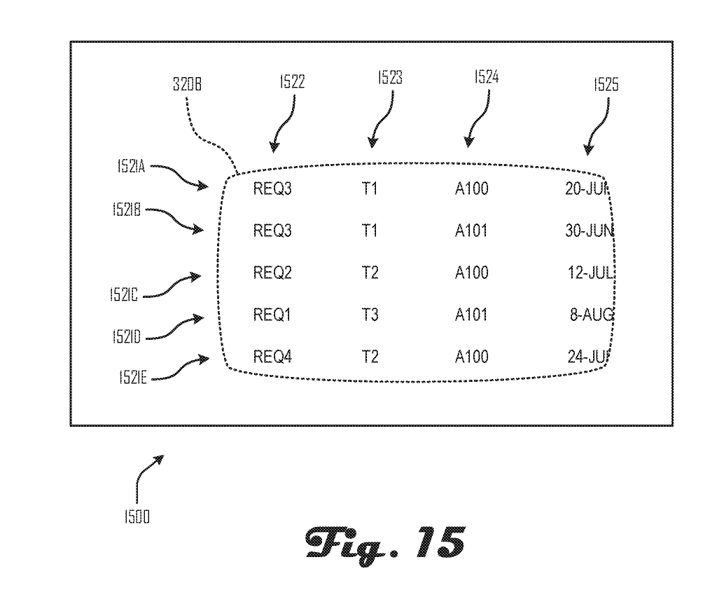

As used herein a “prioritization” or “tier” refers to a value or range of values (expressible as a scalar like “2” or as an alphanumeric expression like “T2,” e.g.) at least one of which likens two or more listed tasksets in importance. This can occur, for example, in a context in which a scheduling specialist thus manifests an indifference to reordering (within tier “T1,” e.g.) that is sufficiently substantial as to invite an automated or semi-automated exploration of possible advantages among the permutations of task processing resequencing even while maintaining a degree of coarse prioritization even while manifesting a preference that scheduling flaws or failures occur among lower-priority tasksets where necessary (i.e. rather than among any higher-priority tasksets). In some variants, for example, a particular taskset (identified as “REQ2” in FIG. 15, e.g.) has a lower prioritization than that of one or more higher-tier tasksets (identified as “REQ3,” e.g.) and a higher prioritization than that of one or more lower-tier tasksets (identified as “REQ1” in FIG. 15, e.g.). Alternatively or additionally, said particular taskset (identified as “REQ2,” e.g.) may have a (nominally) identical prioritization/tier as that of one or more other tasksets (identified as “REQ4,” e.g.).

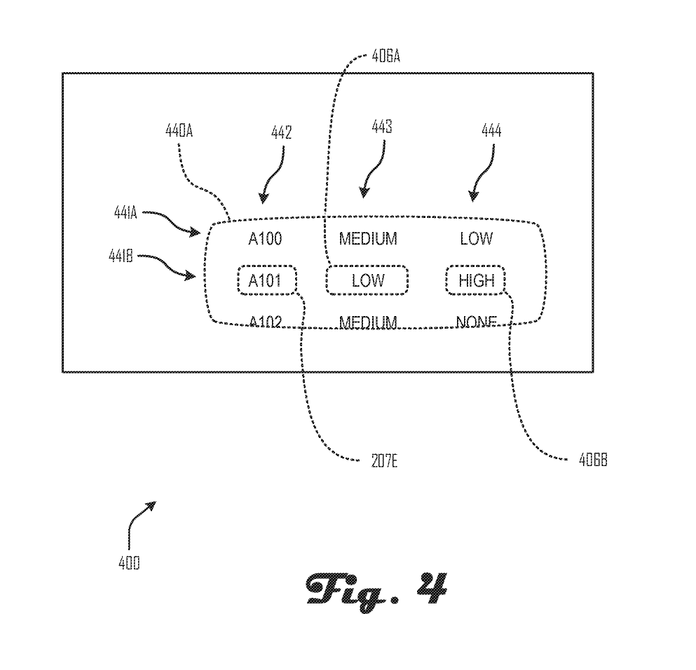

FIG. 4 depicts one or more non-transitory storage media 400 containing first tabular compatibility data 440A. One of a plurality of records 441A-B as shown associates a vehicle 158 identified (as “A101,” e.g.) by an alphanumeric label 207E in a first field 442 with a facility-to-vehicle compatibility index 406A in another field 443 that signifies a compatibility or incompatibility between said vehicle and a particular station 120A. That record 441B likewise associates that vehicle 158 with another facility-to-vehicle compatibility index 406B in another field 443 that signifies a degree of compatibility between said vehicle and another station 120B.

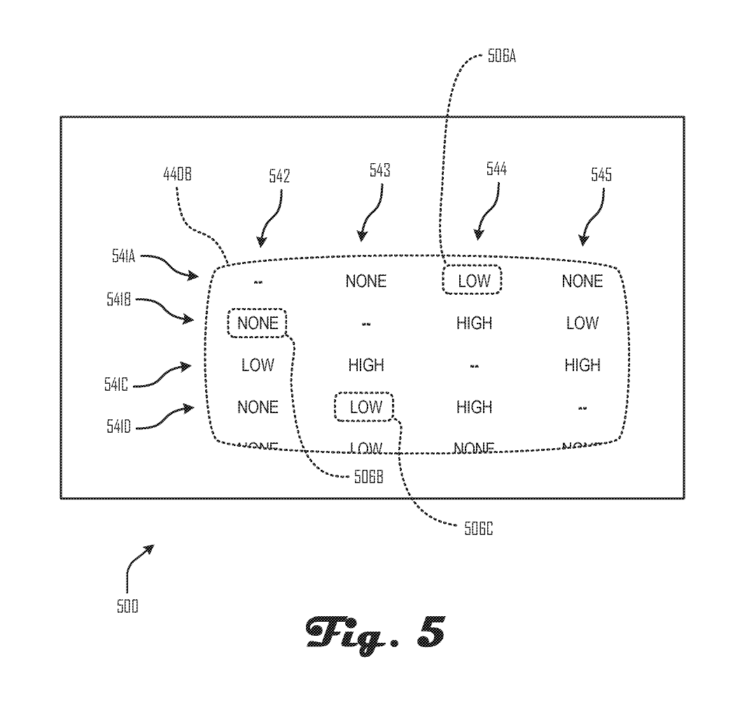

FIG. 5 depicts one or more non-transitory storage media 500 (optionally as an instance of media 400, e.g.) containing second tabular compatibility data 440B. Each of several records 541A-D as shown associates a respective taskset identified (as “REQ1” through “REQ4,” e.g.) with other tasksets. In a context in which fields 542-545 respectively signify “REQ1” through “REQ4” also, taskset-to-taskset compatibility index 506A signifies a “LOW” compatibility between “REQ1” and “REQ3” tasksets. Taskset-to-taskset compatibility index 506B likewise signifies no compatibility whatsoever between “REQ1” and “REQ2” tasksets, and taskset-to-taskset compatibility index 506C signifies “LOW” compatibility between “REQ2” and “REQ4” tasksets.

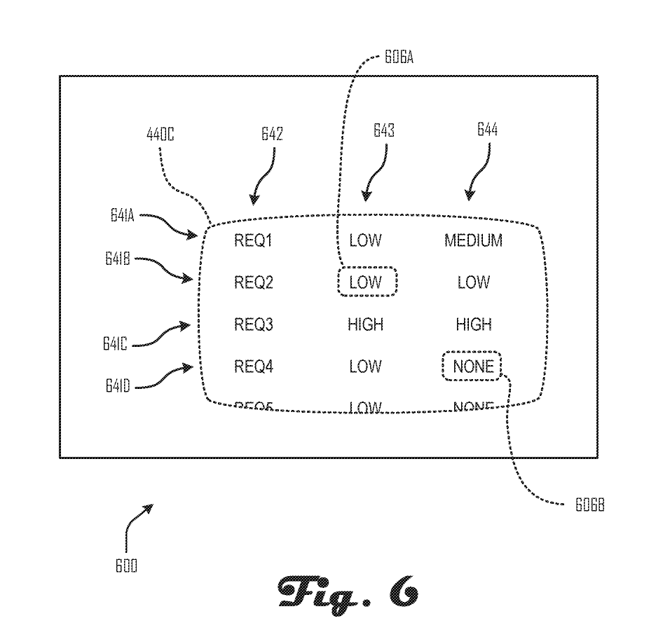

FIG. 6 depicts one or more non-transitory storage media 600 (optionally as an instance of media 500, e.g.) containing third tabular compatibility data 440C. One of a plurality of records 641A-D as shown associates a taskset identified in field 642 with a facility-to-taskset compatibility index 606A in another field 643 that signifies a “LOW” compatibility between said taskset and a particular station 120A. That record 641B likewise associates that “REQ2” taskset with another facility-to-taskset compatibility index 606 (in field 644) that also signifies a “LOW” compatibility (between said taskset and another station 120B). Another record 641D associates a taskset identified as “REQ4” with an incompatibility to station 120B.

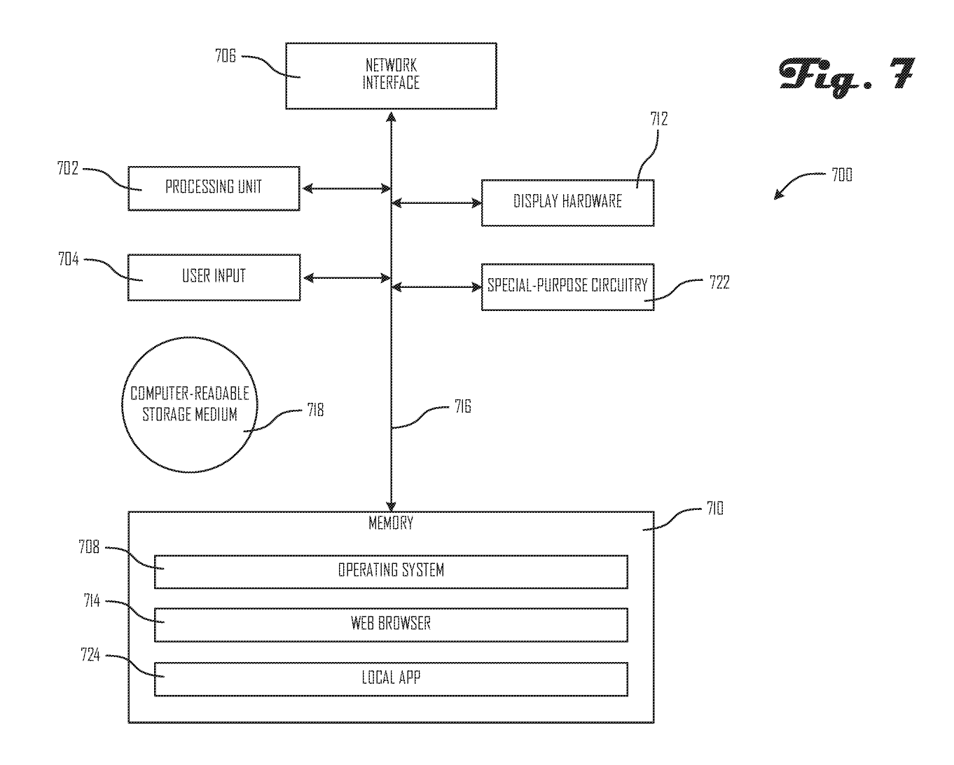

FIG. 7 illustrates a client device 700 in which one or more technologies may be implemented. In respective embodiments, client device 700 may be a general-purpose computer or may include special-purpose components. As shown in FIG. 7, exemplary client device 700 includes one or more processing units 702 in data communication with one or more memories 710 via one or more buses 716. Each such memory 710 generally comprises some or all of random access memory (RAM), read-only memory (ROM), or a permanent mass storage device, such as a disk drive, flash memory, or the like. Client device 700 may also include one or more instances of network interfaces 706, of user inputs 704, of displays 712, of speakers, or of special-purpose circuitry 722 described below.

As shown, memory 710 of exemplary client device 700 may store an operating system 708, as well as program code for a number of software applications, such as a browser 714 or client application 722. Browser 714 is a software application by which, under client device control, client devices 700 can present data to users and transmit data from users. These and other software components, as well as various data files (not shown) may be loaded into memory 710 via network interface 706 (or via a selectively removable computer readable storage medium 718, such as a memory card or the like).

In operation, operating system 708 manages the hardware and software resources of the client device 700 and provides common services for various software applications, such as browser 714. For hardware functions such as network communications via network interface 706, obtaining data via user input 704, rendering data via displays 712 or speakers, allocation of memory 710 to various resources, operating system 708 may act as an intermediary between software executing on client device 700 and the client device's hardware.

For example, operating system 708 may cause a representation of locally available software applications, such as browser 714, to be rendered locally (via display 712, e.g.). If operating system 708 obtains, e.g. via user input 704, a selection of browser 714, operating system 708 may instantiate a browser application process (not shown), i.e. cause processing unit 702 to begin executing the executable instructions of browser 714 and allocate a portion of memory 710 for its use. In some contexts, special-purpose circuitry 722 may require an access control feature (a dongle, e.g.) configured to prevent unauthorized downloads (of local apps 724 or tabular compatibility data 440, e.g.) and to permit specially-configured client devices to access server 800. Alternatively or additionally, some functions may occur “offline” in the sense that the client device 700 is temporarily disconnected from server 800.

Although an exemplary client device 700 has been described, a client device 700 may be a mobile device or other device capable of executing program code, such as the program code corresponding to browser 714. Alternatively or additionally, the structures described with reference to FIG. 7 may likewise be implemented by a special-purpose peer computer in a peer-to-peer network.

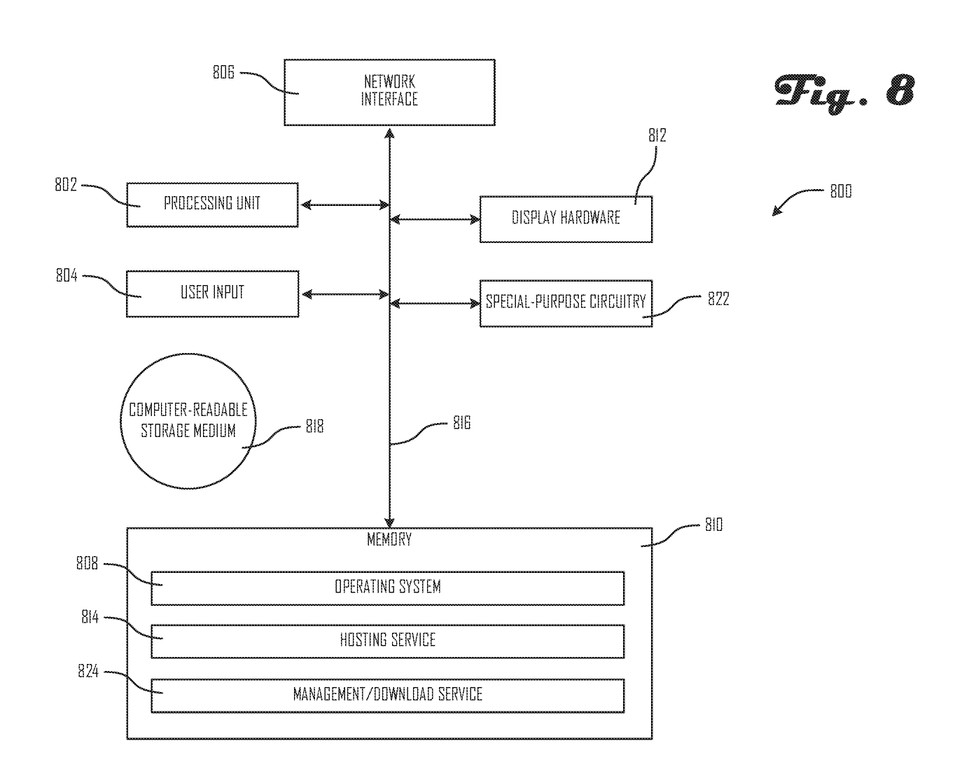

FIG. 8 illustrates a server 800 in which one or more technologies may be implemented. In respective embodiments, server 800 may be a general-purpose computer or may include special-purpose components. As shown in FIG. 8, exemplary server 800 includes one or more processing units 802 in data communication with one or more memories 810 via one or more buses 816. Each such memory 810 generally comprises some or all of random access memory (RAM), read-only memory (ROM), or a permanent mass storage device, such as a disk drive, flash memory, or the like. Server 800 may also include one or more instances of network interfaces 806, of user inputs 804, of displays 812, of speakers, or of special-purpose circuitry 822 described below.

As shown, memory 810 of exemplary server 800 may store an operating system 808, as well as program code for a number of software applications, such as a hosting service 814 or client application 822. Hosting service 814 is a software application by which, under server control, client devices 700 can present data to users and transmit data from users. These and other software components, as well as various data files (not shown) may be loaded into memory 810 via network interface 806 (or via a selectively removable computer readable storage medium 818, such as a memory card or the like).

In operation, operating system 808 manages the hardware and software resources of the server 800 and provides common services for various software applications, such as hosting service 814. For hardware functions such as network communications via network interface 806, obtaining data via user input 804, rendering data via displays 812 or speakers, allocation of memory 810 to various resources, and invoking special-purpose circuitry 822, operating system 808 may act as an intermediary between software executing on server 800 and the server's hardware.

For example, operating system 808 may cause a representation of locally available software applications, such as browser 814, to be rendered locally (via display 812, e.g.). If operating system 808 obtains, e.g. via user input 804, a selection of browser 814, operating system 808 may instantiate a browser application process (not shown), i.e. cause processing unit 802 to begin executing the executable instructions of browser 814 and allocate a portion of memory 810 for its use. In some contexts, special-purpose circuitry 822 may require an access control feature (a dongle, e.g.) configured to prevent unauthorized downloads (of local apps 824 or tabular compatibility data 440, e.g.) and to permit specially-configured client devices to access server 800. Alternatively or additionally, some functions may occur “offline” in the sense that the server 800 is temporarily disconnected from server 800.

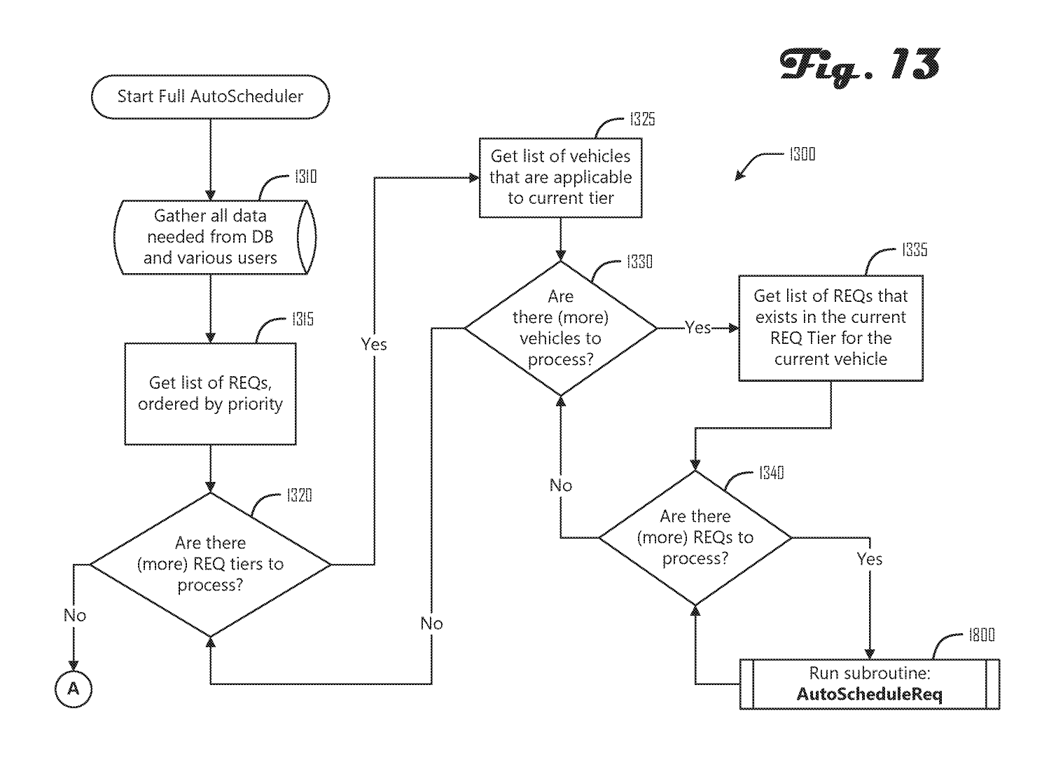

For example, operating system 808 may cause a representation of locally available software applications, such as hosting service 814, to be rendered locally (via display 812, e.g.). If operating system 808 obtains, e.g. via user input 804, a selection of hosting service 814, operating system 808 may instantiate a hosting service process, i.e. cause processing unit 802 to begin executing the executable instructions of hosting service 814 and allocate a portion of memory 810 for its use. Alternatively or additionally, operating system 808 may instantiate a process flow management service or download service 824, including one or more operational sequences described herein (with regard to FIG. 13 et seq., e.g.).

Although an exemplary server 800 has been described, a server 800 may be a mobile device or other device capable of executing program code, such as the program code corresponding to browser 814. Alternatively or additionally, the structures described with reference to FIG. 8 may likewise be implemented by a special-purpose peer computer in a peer-to-peer network.

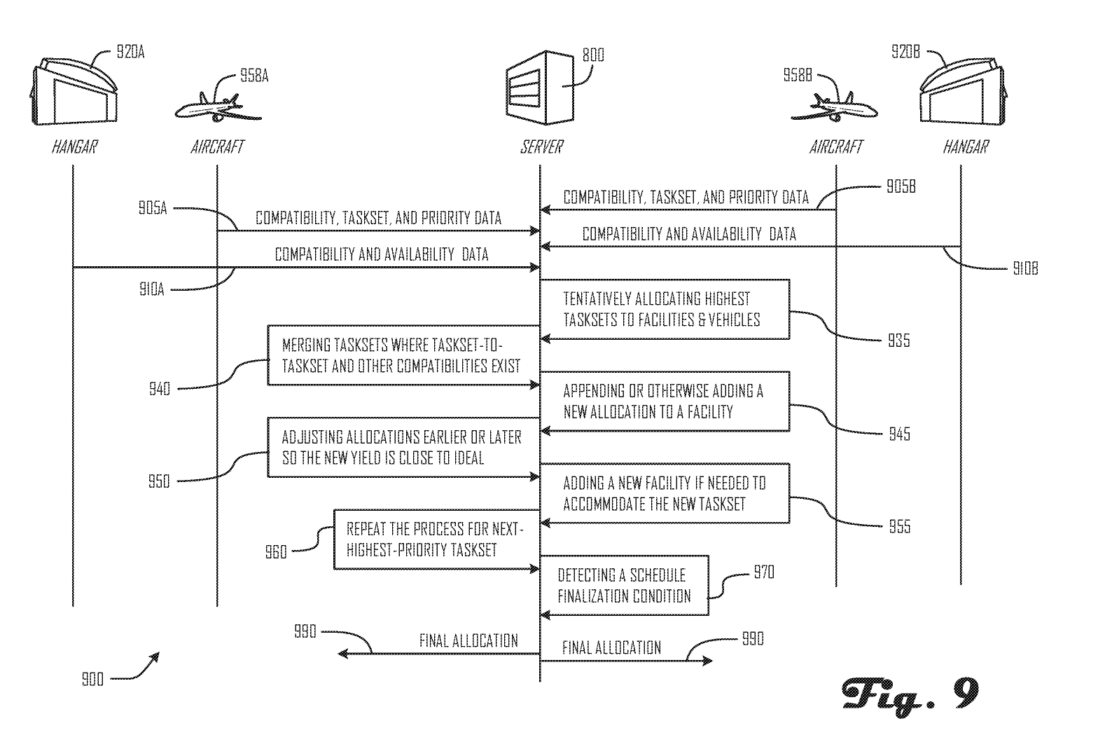

FIG. 9 depicts a data flow 900 in which one or more servers 800 interacts with one or more instances of client devices 700. Special purpose circuitry 722 (aboard or otherwise) uniquely associated with each respective aircraft 958A-B or other vehicle 158 needing maintenance provides current compatibility, taskset, and priority data 905A-B to the one or more servers 800. Likewise special purpose circuitry 722 (within or otherwise) uniquely associated with each respective hangar 920A-B or other service station 120 provides current compatibility and availability data 910A-B to the one or more servers 800. In some contexts, for example, such data may include updates specified by a fleet owner, service facility, or scheduling specialist. Such updates may affect one or more instances of taskset completion deadlines 264, of minimum yields 261, of maximum yields 263, of primary target yields 262, of taskset lists 320 (or definitions of tasksets identified therein, e.g.), or of tabular compatibility data 440 like those described above.

In a manner that is responsive to said compatibility and other data, tasksets are tentatively scheduled/allocated (automatically and conditionally) each to a corresponding facility and vehicle 935 in sequence. In some contexts tasksets are merged 940 where warranted by provided indicia of vehicle-to-facility incompatibility (of tabular compatibility data 440A, e.g.) or facility-to-taskset incompatibility (of tabular compatibility data 440C, e.g.) generally as exemplified below. Alternatively or additionally, such taskset merger may occur as a conditional response to provided indicia of a degree of taskset-to-taskset compatibility (of tabular compatibility data 440B, e.g.), availability of a company-internal or other preferred service facility (according to a proximity of a station 120 to a projected location of the vehicle, e.g.), or other such determinants described herein (or a combination thereof, e.g.). Where appropriate in light of a burn rate of a taskset scheduled at a facility, a duration of the taskset may be lengthened (relative to a standard duration of an unmerged component taskset) so as to provide a merged-taskset-duration that is less than a sum of the durations of the component tasksets but more than a longest one of the component tasksets merged.

Also in a manner that is responsive to said compatibility and other data, one or more tasksets may be tentatively scheduled/allocated (automatically and conditionally) each to a corresponding facility and vehicle 935 in sequence by appending a taskset to a suitable time slot at a facility 945 where warranted by provided indicia of vehicle-to-facility incompatibility (of tabular compatibility data 440A, e.g.) or facility-to-taskset incompatibility (of tabular compatibility data 440C, e.g.) generally as exemplified below. Alternatively or additionally, such taskset appendment may occur as a conditional response to provided indicia of a degree of taskset-to-taskset compatibility (of tabular compatibility data 440B, e.g.), availability of a company-internal or other preferred service facility (according to a proximity of a station 120 to a projected location of the vehicle, e.g.), or other such determinants described herein (or a combination thereof, e.g.).

Also in a manner that is responsive to said compatibility and other data, one or more such allocations may be adjusted 950 such as by (automatically and conditionally) iteratively determining a viability of moving one or more prior allocations at a given facility to an earlier time so as to allow said new allocation to achieve or approximate the primary target yield. Alternatively or additionally, one or more such allocations may likewise be adjusted 950 by iteratively determining a viability of moving one or more prior allocations at a given facility to a later time (increasing from a primary target yield 262 of one or more prior allocations up to a maximum yield 263, e.g.) to the degree necessary as to allow said new allocation to achieve or approximate its respective primary target yield 262. Where such sliding and stacking (or “cascading”) will be successful to allow said new allocation to achieve or approximate its respective primary target yield 262, the movement is adopted into the tentative schedule in progress.

Otherwise a new (virtual or defined premium) facility may be added as needed to accommodate the new taskset 955 and the process is repeated 960 for each same-priority or next-highest priority taskset provided in taskset list 320. Upon the one or more servers 800 detecting a schedule finalization condition 970 (as a user validation or satisfactory allocation not requiring virtual or premium resources, e.g.) signifying a finalized schedule or schedule update, one or more components/allocations 990 thereof is disseminated (to the vehicles 158 and stations 120, e.g.) to each entity affected by the allocation(s) as a real-time response (i.e. within a minute) to a finalization of a new or newly-updated schedule. In some contexts in which many such entities rely that upon and are relied upon to act in a manner consistent with a schedule are geographically dispersed (i.e. one or more hours' travel from a server 800 or a facility/vehicle to which a new schedule allocates them), such updates (as an instance of a final allocation 990 to one or more remote facilities/vehicles, e.g.) occurring in real time allows for reallocations (adapting an allocation as described herein that reroutes a remote vehicle in transit to accommodate an allocation for which a newly finalized taskset start time index 1172 will occur in less than 24 hours, e.g.) that would not otherwise be feasible to implement safely.

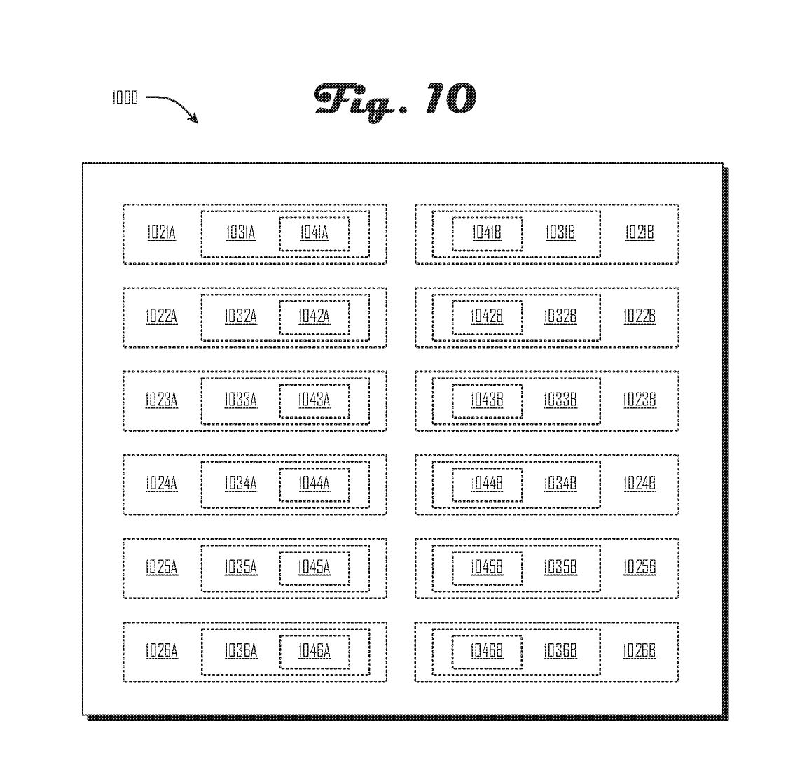

FIG. 10 illustrates special-purpose transistor-based circuitry 1000—optionally implemented as an Application-Specific Integrated Circuit (ASIC), e.g.—in which some or all of the functional modules described below may be implemented. Transistor-based circuitry 1000 is an event-sequencing structure generally as described in U.S. Pat. Pub. No. 20150094046 but configured as described herein. Transistor-based circuitry 1000 includes one or more instances of input or aggregation modules 1021A-B, for example, each including an electrical node set 1031A-B upon which addresses of tabular compatibility data 440 or user input (menu selections, e.g.) is represented digitally as a corresponding voltage configuration 1041A-B. Exemplary functioning of such modules is described below.

In the interest of concision and according to standard usage in information management technologies, the functional attributes of modules described herein are set forth in natural language expressions. It will be understood by those skilled in the art that such expressions (functions or acts recited in English, e.g.) adequately describe structures identified below so that no undue experimentation will be required for their implementation. For example, any records or other informational data identified herein may easily be represented digitally as a voltage configuration on one or more electrical nodes (conductive pads of an integrated circuit, e.g.) of an event-sequencing structure without any undue experimentation. Each electrical node is highly conductive, having a corresponding nominal voltage level that is spatially uniform generally throughout the node (within a device or local system as described herein, e.g.) at relevant times (at clock transitions, e.g.). Such nodes (lines on an integrated circuit or circuit board, e.g.) may each comprise a forked or other signal path adjacent one or more transistors. Moreover many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision or other digital data.

Transistor-based circuitry 1000 may likewise include one or more instances of invocation or aggregation modules 1022A-B, for example, each including an electrical node set 1032A-B (of one or more nodes) upon which addresses of lists 320 (of tasksets or vehicles 158, e.g.) or other informational data is represented digitally as a corresponding voltage configuration 1042A-B as shown. Transistor-based circuitry 1000 may likewise include one or more instances of invocation or decision modules 1023A-B, for example, each including an electrical node set 1033A-B upon which determinations or identifiers (of alphanumeric/scalar determinants, e.g.) or other informational data is represented digitally as a corresponding voltage configuration 1043A-B as shown. Transistor-based circuitry 1000 may likewise include one or more instances of invocation or association modules 1024A-B, for example, each including an electrical node set 1034A-B upon which tasksets or vehicles (or associations thereof) or other informational data is represented digitally as a corresponding voltage configuration 1044A-B as shown. Transistor-based circuitry 1000 may likewise include one or more instances of invocation or processing modules 1025A-B, for example, each including an electrical node set 1035A-B upon which determinations or identifiers (of dates or slack values, e.g.) or other informational data is represented digitally as a corresponding voltage configuration 1045A-B as shown. Transistor-based circuitry 1000 may likewise include one or more instances of storage or dissemination modules 1026A-B, for example, each including an electrical node set 1036A-B upon which predetermined data destinations (dedicated to handlong a finalized maintenance schedule or component thereof, e.g.) or other informational data is represented digitally as a corresponding voltage configuration 1046A-B as shown. Transistor-based circuitry 1000 may likewise include one or more instances of update modules, for example, each including an electrical node set upon which user input or other informational data is represented digitally as a corresponding voltage configuration. Exemplary functioning of such modules is described below. In some variants, moreover, distributed special-purpose modules implement such functionality jointly (in conjunction with other modules or processing units described herein, e.g.).

FIG. 11 presents components of allocations or other expressions as an image 1100 (displayed via display hardware 712 of a vehicle 158 or other client device 700, e.g.) of a schedule in progress. A timeline 1160 is presented relative to several successive intervals 1165 of time (each being a day, week, or month, e.g.) and a current time marker 250B. Image 1100 simultaneously presents a plurality of expressions 1105A-B that each include a label 1107 that distinctly identifies a station 120 (a hangar 920 or assembly line, e.g.) at which maintenance tasksets may performed upon a succession of vehicles 158.

To obtain image 1100 in in a context that combines all of the foregoing FIGS. 1-10, one or more input modules 1021 gather data including compatibility, taskset, and priority data 905 in relation to a plurality of vehicles 158 and including compatibility and availability data 910 in relation to a plurality of stations 120 (within a single facility or among different facilities, e.g.). One or more aggregation modules 1022 receive (at least access to) a list 320 of tasksets to be scheduled including a first record 321A that associates a taskset identifier 322 with a single corresponding criticality-indicative category 323, vehicle identifier 324, and completion deadline 325. Using the deadline 325 in record 321A (shown as deadline 264B in FIG. 2, e.g.) and a maintenance taskset history (reflecting when “REQ3” was performed last upon the vehicle 158 identified as “A101,” e.g.), aggregation module 1022 may determine one or more of when a maximum acceptable yield 263B (corresponding to a value between 97% and 99%, e.g.) may be implemented, when a minimum acceptable yield 261B (corresponding to a value between 80% and 92%, e.g.) may be implemented, and when a target (ideal) yield 262B (corresponding to a value between 93% and 96%, e.g.) may be implemented with regard to a particular vehicle (identified as “A101,” e.g.) as illustrated in FIG. 2. In a context in which a scheduling specialist has set a primary target yield 262B at 95%, for example, processing module 1025A may establish an allocation 1170A based upon record 321A tentatively to schedule a taskset 322 identified as “REQ3” to be performed upon a vehicle identified as “A101” at a facility identified as “XY21.” In some variants this may define one or more of an allocation start time index 1171A or a taskset start time index 1172A (or both). Alternatively or additionally allocation 1170A may define one or both of a taskset end time index 1173A or an allocation end time index 1174A (or both) so as to finish several days before the completion deadline of June 30. The respective differences between each allocation start/end indexes 1171, 1174 and its corresponding taskset start/end time index are preferably depicted as a cap that is shown in a substantially different shade, either being at least 10% lighter or at least 10% darker relative to the body (middle portion) of the graphical allocation. In a context in which image 1100 is shown on a full-size display or on a paper printout, each allocation 1170 is optionally represented as a rectangle in which both the vehicle and taskset are explicitly identified (with both an alphanumeric label of “REQ3” to designate the taskset 322 and an alphanumeric label of “A101” to designate the vehicle, e.g.). More importantly, the presence of allocation 1170A in expression 1105A signifies to the scheduling specialist both (a) that a facility-to-taskset compatibility (denoted as a compatibility index 606 of “LOW” or better, e.g.) exists between the station 120 identified as “XY21” and the taskset 322 identified as “REQ3” and (b) that a facility-to-vehicle compatibility (denoted as a compatibility index 406 of “LOW” or better, e.g.) exists between the station 120 identified as “XY21” and the vehicle 158 identified as “A101.”

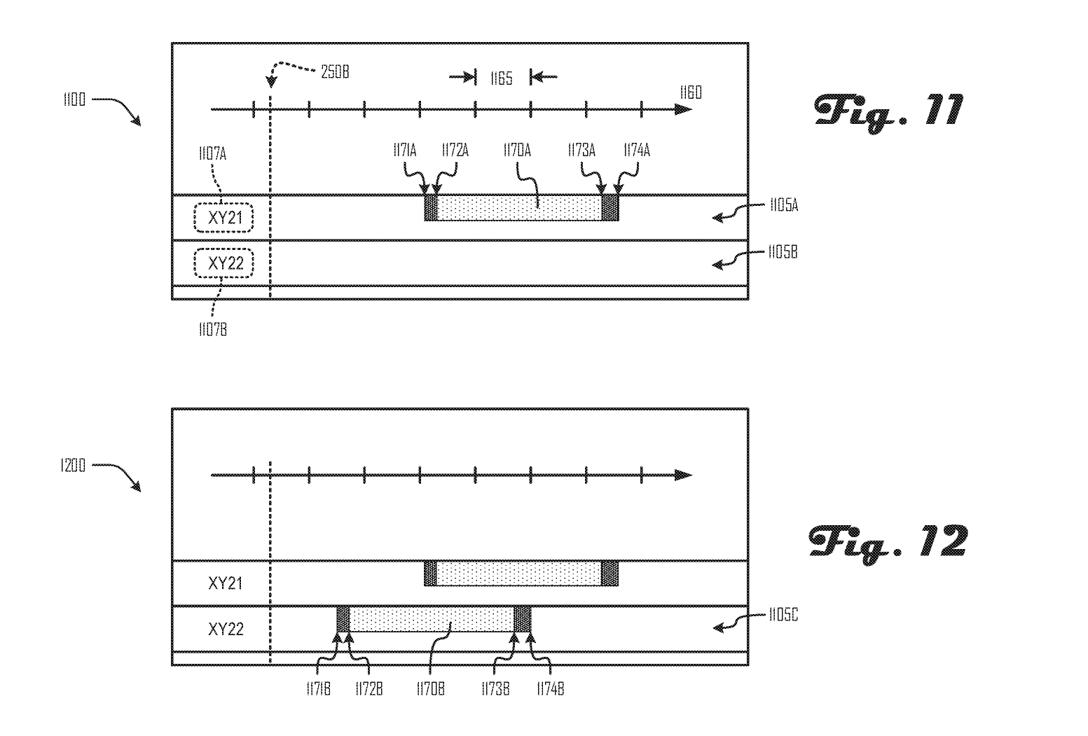

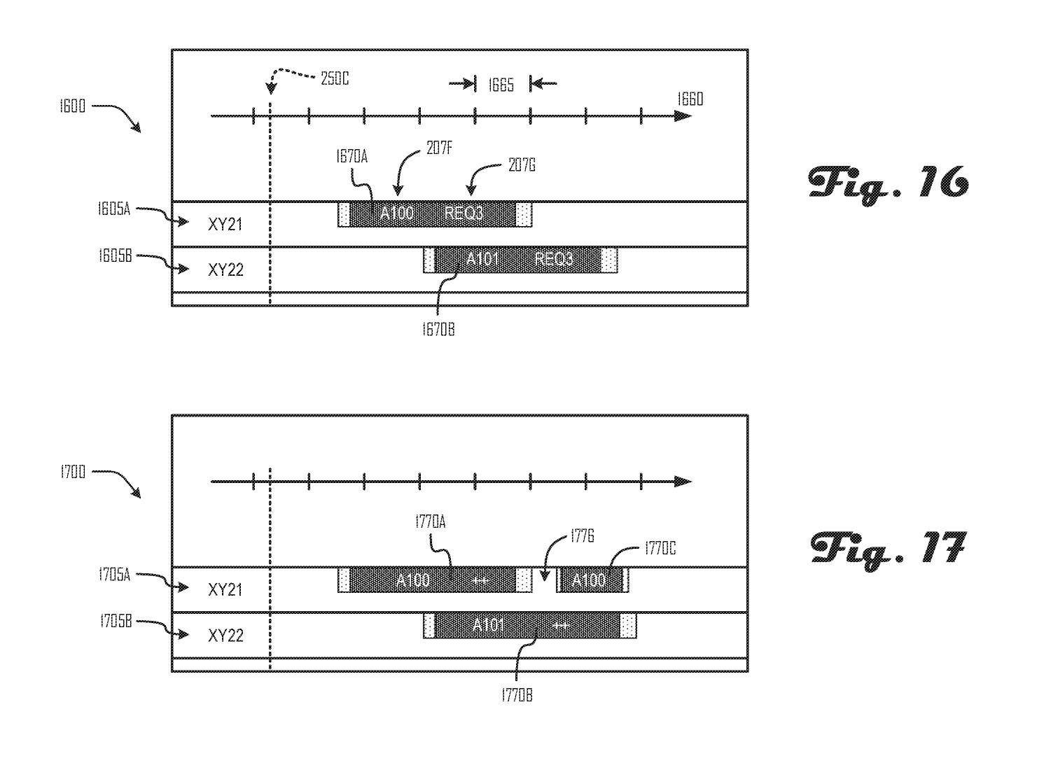

FIG. 12 presents components of allocation or other expressions as an image 1200 of a schedule in progress further along than that of FIG. 11. Image 1200 simultaneously presents a plurality of expressions 1105 that each include a label 1107 that respectively identifies a station 120 at which maintenance tasksets may performed upon a succession of vehicles 158. A second record 321B that associates a taskset identifier 322 with a single corresponding criticality-indicative category 323, vehicle identifier 324, and completion deadline 325. Using the deadline 325 in record 321B (shown as deadline 264A in FIG. 2, e.g.) and a maintenance taskset history (reflecting when “REQ3” was performed last upon the vehicle 158 identified as “A100,” e.g.), aggregation module 1022 may determine one or more of when a maximum acceptable yield 263A (corresponding to a value between 97% and 99%, e.g.) may be implemented, when a minimum acceptable yield 261A (corresponding to a value between 80% and 92%, e.g.) may be implemented, and when a target (ideal) yield 262A (corresponding to a value between 93% and 96%, e.g.) may be implemented with regard to a particular vehicle (identified as “A100,” e.g.) as illustrated in FIG. 2. In a context in which a scheduling specialist has set a primary target yield 262A at 95%, for example, processing module 1025A may establish an allocation 1170B based upon record 321B tentatively to schedule a taskset 322 identified as “REQ3” to be performed upon a vehicle identified as “A100” at a facility identified as “XY22.” In some variants this may define one or more of an allocation start time index 1171B or a taskset start time index 1172B (or both). Alternatively or additionally allocation 1170B may define one or both of a taskset end time index 1173B or an allocation end time index 1174B (or both) so as to finish several days before the completion deadline of June 20. Each allocation 1170 is (optionally) represented as a rectangle in which both the vehicle and taskset are explicitly identified (with both an alphanumeric label of “REQ3” to designate the taskset 322 and an alphanumeric label of “A100” to designate the vehicle, e.g.). See FIG. 16. More importantly, the presence of allocation 1170B in expression 1105C signifies to the scheduling specialist both (a) that a facility-to-taskset compatibility (denoted as a compatibility index 606 of “LOW” or better, e.g.) exists between the station 120 identified as “XY22” and the taskset 322 identified as “REQ3” and (b) that a facility-to-vehicle compatibility exists between the station 120 identified as “XY22” and the vehicle 158 identified as “A100.”

In thus generating FIGS. 11 and 12, highest-priority (expressed as “T1,” e.g.) tasksets were each allocated tentatively 935 to respective stations 120 and vehicles 158 exactly at each of their respective primary target yields (for exactly 95% yield, e.g.). No merging 940, appending 945, adjusting 950, or adding a new facility 955 has yet been done.

In the tabular compatibility data 440 exemplified herein, at least one participating facility/station 120 is incompatible with at least one vehicle 158 to be updated/improved/maintained or with at least one listed taskset to be performed (or both). In repeating the allocation process 960 for the next-highest-priority taskset (the “T2” taskset identified as “REQ4” to be performed upon the vehicle 150 identified as “A100” on or before July 24 according to record 321C, e.g.), unfortunately it will be noted that record 641D indicates a total absence of compatibility between the taskset identified as “REQ4” and the facility/station 120 identified as “XY22” (manifested as a facility-to-taskset compatibility index 606B of “NONE” in FIG. 6, e.g.). In various embodiments or contexts, special-purpose circuitry 1000 may respond to such incompatibility with a preliminary schedule signaling (a) that the “A100” vehicle be maintained at one facility and later at another facility or (b) that not all identified tasksets will be performed or (c) that the “REQ4” taskset will be performed at a virtual “overflow” facility signaling to the scheduler that the available facilities are apparently insufficient for the taskset list given the current constraints. In these or other circumstances in which a scheduling specialist is unsatisfied with an outcome, the present system allows the yields, priorities, or other constraints to be adapted and the circuitry 1000 invoked again. When such adjustments resolves such undesirable conditions a scheduling finalization condition 970 (a user input of “finalize this schedule,” e.g.) is detected and the final allocation 990 is disseminated (to vehicles 158, facilities/stations 120, or other client devices 700 as appropriate). In some variants each permutation of list 320A is tried (reordering the “Tier 1” records 321A-B in every possible way and choosing one or more best schedule outcomes, e.g.) in succession, each time presenting a success index (an overflow taskset count or other failure count, e.g.) and allowing a scheduling specialist to keep the permutation or try another. An effect of such a reordering is presented below with reference to FIG. 15 et seq.

FIG. 13 illustrates an automatic or semi-automatic scheduling routine 1300 suitable for use with at least one embodiment, such as transistor-based circuitry 1000 (implemented as special-purpose circuitry 722, 822, e.g.) being invoked by server 800 during the data flow 900 of FIG. 9. As will be recognized by those having ordinary skill in the art, not all events of information management are illustrated in FIG. 13. Rather, for clarity, only those steps reasonably relevant to describing the automatic or semi-automatic maintenance scheduling aspects of routine 1300 are shown and described. Those having ordinary skill in the art will also recognize the present embodiment is merely one exemplary embodiment and that variations on the present embodiment may be made without departing from the scope of the broader inventive concept set forth herein.

Following a start operation, execution block 1310 depicts gathering all data needed from one or more databases and one or more users (e.g. one or more modules 1021A-B triggering aggregation of compatibility, taskset, and priority data 905 and compatibility and availability data 910 as described above). Execution then proceeds to execution block 1315.

Execution block 1315 depicts getting a list of requirements/tasksets ordered by priority (e.g. one or more modules 1022A-B triggering an acquisition of taskset list 320 as described herein). In some instances this may include sorting the list (by criticality-indicative category 323, e.g.) or inviting a scheduling specialist to trigger automatic successions of variously-reordered permutations (within each given tier having two or more records as depicted in FIGS. 3 and 15, e.g.). Execution then proceeds to decision block 1320.

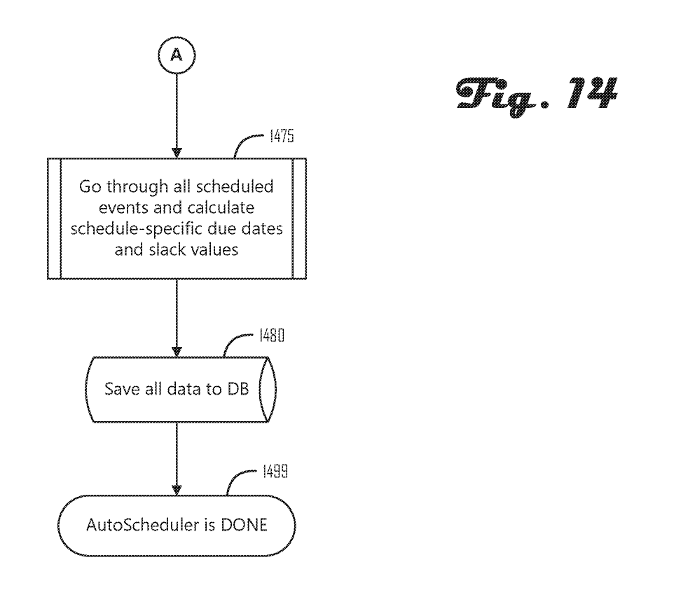

At decision block 1320, if there are more tiers of tasksets to process, execution proceeds to execution block 1325. Otherwise execution proceeds to waypoint “A” (continued at FIG. 14).

Execution block 1325 depicts getting a list of vehicles that are applicable to the current (highest incomplete) tier (e.g. one or more modules 1023B triggering a listing of vehicles for which one or more tasksets need to be scheduled). Execution then proceeds to decision block 1330.

At decision block 1330, if there are no more vehicles to process (e.g. as determined by module 1024B, e.g.), execution proceeds back to decision block 1320. Otherwise execution proceeds to execution block 1335.

Execution block 1335 depicts getting a list of tasksets that exist in the current tier for the current vehicle (e.g. module 1024A extracting a list with one or more tasksets that might be merged if a higher-than-minimal compatibility, one having an index that is not “NONE” or “LOW”). Execution then proceeds to decision block 1340.

At decision block 1340, if there are more tasksets/requirements to process (e.g. as determined by module 1025B, e.g.), execution proceeds back to decision block 1320. Otherwise execution proceeds to subroutine 1800.

FIG. 14 illustrates an extension of automatic or semi-automatic scheduling routine 1300 continuing from waypoint “A” (continued from FIG. 13).

Subroutine 1475 depicts going through all scheduled events and calculating schedule-specific operational metrics (e.g. module 1025A determining one or more errors, slack values, due dates, performance metrics, or the like). Execution then proceeds to execution block 1480. Execution then proceeds to execution block 1480.

Execution block 1480 depicts saving all data to a database (e.g. module 1026A disseminating a final schedule or component allocations 990 thereof to one or more vehicles 158 or stations 120). Execution ends at block 1499.

FIG. 15 depicts a taskset list 320B comprising several records 1521A-E all stored on one or more non-transitory media 1500. As shown each such record includes a taskset identifier 1522 respectively associated with a criticality-indicative category 1523, a vehicle identifier 1524, and a completion deadline 1525 (each comprising one or more scalars or alphanumeric labels, e.g.). Relative to the taskset list 320A of FIG. 3, it will be noted that this taskset list 320B has its first-tier records reordered so that they will be processed in a different order. Also two new tasksets have been added corresponding to records 1521C-D. Also the records are not prioritized. A correct processing of this dataset will therefore include a sequencing in which record 1521E is processed before record 1521D.

FIG. 16 presents components of allocation or other expressions as an image 1600 (displayed via display hardware 712 of a vehicle 158 or other client device 700, e.g.) of a schedule in progress. A timeline 1660 is presented relative to several successive intervals 1665 of time (each being a week, month, or quarter, e.g.) and a current time marker 250C. Image 1600 simultaneously presents a plurality of expressions 1605A-B that each include a label that specifically identifies a station 120 (a hangar 920 or other track, e.g.) at which maintenance tasksets may performed upon a succession of vehicles 158.

To obtain image 1600 automatically in in a context that combines most or all of the foregoing FIGS. 1-15, one or more input modules 1021 gather data including compatibility, taskset, and priority data in relation to a plurality of vehicles 158 and including compatibility and availability data in relation to a plurality of stations 120 (within a single facility or among different facilities, e.g.). One or more aggregation modules 1022 receive (at least access to) a list 320B of tasksets to be scheduled including a first record 1521A that associates a taskset identifier 1522 with at least a single corresponding criticality-indicative category 1523 and vehicle identifier 1524. As described above with reference to FIG. 3, aggregation module 1022 may determine one or more of when a maximum acceptable yield 263A (corresponding to a value between 97% and 99%, e.g.) may be implemented, when a minimum acceptable yield 261A (corresponding to a value between 80% and 92%, e.g.) may be implemented, and when a target (ideal) yield 262A (corresponding to a value between 93% and 96%, e.g.) may be implemented with regard to a particular vehicle (identified as “A100,” e.g.) as illustrated in FIG. 2. In a context in which a scheduling specialist has set a primary target yield 2622 at 95%, for example, processing module 1025A may establish an allocation 1670A based upon record 1521A tentatively to schedule a vehicle identified as “A100” to undergo a taskset 1522 identified as “REQ3” (respectively identified by alphanumeric labels 207F-G as shown in a rectangle representing the allocation 1670A, e.g.) at a facility identified as “XY21.” In some variants this may define one or more of an allocation start time index or a taskset start time index (or both). Alternatively or additionally allocation 1670A may define one or both of a taskset end time index or an allocation end time index (or both) so as to finish several days before the completion deadline of June 20. The respective differences between each allocation start/end indexes and its corresponding taskset start/end time index are again depicted as a cap that is shown in a substantially different shade, either being at least 10% lighter or at least 10% darker relative to the body (middle portion) of the graphical allocation. Each allocation 1670 is represented as a rectangle in which at least the vehicle is explicitly identified (with an alphanumeric label of “A101” to designate the vehicle, e.g.) and the taskset(s) also shown where legibility is achievable. More importantly, the presence of allocation 1670A in expression 1605A signifies to the scheduling specialist both (a) that a facility-to-taskset compatibility (denoted as a compatibility index 606 of “LOW” or better, e.g.) exists between the station 120 identified as “XY21” and the taskset 1522 identified as “REQ3” and (b) that a facility-to-vehicle compatibility (denoted as a compatibility index 406 of “LOW” or better, e.g.) exists between the station 120 identified as “XY21” and the vehicle 158 identified as “A100.”

Image 1600 also (simultaneously) includes a graphical expression 1605B reflecting a successful allocation of record 1521B and a maintenance taskset history (reflecting when “REQ3” was performed last upon the vehicle 158 identified as “A101,” e.g.) in which aggregation module 1022 has determined one or more of when a maximum acceptable yield (corresponding to a value between 97% and 99%, e.g.) may be implemented, when a minimum acceptable yield (corresponding to a value between 80% and 92%, e.g.) may be implemented, and when a target (ideal) yield (corresponding to a value between 93% and 96%, e.g.) may be implemented with regard to a particular vehicle (identified as “A101,” e.g.) as illustrated in FIG. 2. In a context in which a scheduling specialist has set a primary target yield 262B at 95%, for example, processing module 1025A may establish an allocation 1670B based upon record 1521B tentatively to schedule a taskset 1522 identified as “REQ3” to be performed upon a vehicle identified as “A101” at a facility identified as “XY22” (as a conditional response to the scheduling specialist having provided an input dataset comprising a resequenced taskset list 320B in which record 1521A precedes record 1521B, e.g.) so as to finish several days before the completion deadline of June 30. Each allocation 1670 is optionally represented as a rectangle in which both the vehicle and taskset(s) are explicitly identified. More importantly, the presence of allocation 1670B in expression 1605C signifies to the scheduling specialist both (a) that a facility-to-taskset compatibility (denoted as a compatibility index 606 of “LOW” or better, e.g.) exists between the station 120 identified as “XY22” and the taskset 1522 identified as “REQ3” and (b) that a facility-to-vehicle compatibility exists between the station 120 identified as “XY22” and the vehicle 158 identified as “A101.” In a context in which dozens or hundreds of such records 1521 in a taskset list 320 must all be allocated into a coherent schedule for a fleet of many vehicles (i.e. one in which no allocation of a higher-than-lowest tier taskset invokes a virtual facility or other error manifestation), finalized, and disseminated (according to most or all of the events depicted in FIG. 9, e.g.) all within ten minutes of a last change to the input data (taskset list 320 or tabular compatibility data 440, e.g.) upon which it was based in order for a given schedule update to occur, that schedule update could not occur prior to the technologies set forth herein. For at least this reason, technologies presented herein make possible schedule updates (manifesting a tight window of opportunity, e.g.) that were previously impossible even with a computer.

FIG. 17 presents components of allocation or other expressions as an image 1700 of an automated schedule in progress further along than that of FIG. 16. A timeline is presented relative to several successive intervals of time and a current time marker, just as in FIG. 16. Image 1700 simultaneously presents a plurality of expressions 1705A-B reflecting that record 1521C has been scheduled into allocation 1770A by merging the first “T2” (intermediate criticality) taskset “REQ2” with the “REQ3” taskset of allocation 1670A partly based on the requisite compatibilities and partly based on the requisite yields. It will be noted that the burn rate 125 of the “XY21” facility is high enough that this taskset merger did not extend allocation 1770A beyond the scheduled completion of allocation 1670A. Expression 1705B also reflects that record 1521E has been scheduled into allocation 1770B by merging the next “T2” (intermediate criticality) taskset “REQ4” with the “REQ3” taskset of allocation 1670B partly based on the requisite compatibilities and partly based on the requisite yields. It will be noted that the burn rate 125 of the “XY22” facility is low enough that this taskset merger significantly extended allocation 1770B beyond the scheduled completion of allocation 1670B.

Upon scheduling the last-processed record 1521D (having “T3” lower criticality, e.g.) expression 1705A also reflects that record 1521D has been scheduled into allocation 1770B by placing taskset “REQ1” at its primary target yield 262 partly based on the requisite compatibilities notwithstanding a gap 1776 of idle time longer than one day between two successive allocations 1770A, 1770C concerning tasklists to be performed on a single vehicle at a facility. Such gaps 1776 will readily be noticed where alphanumeric labels indicative of a vehicle identifier are placed in an expression 1705 and may be advantageous for additional scheduling that occurs later, after more records 1521 are added. Also it may be noted that the burn rate 125 of the “XY22” facility is low enough that this taskset merger significantly extended allocation 1770B beyond the scheduled completion of allocation 1670B.

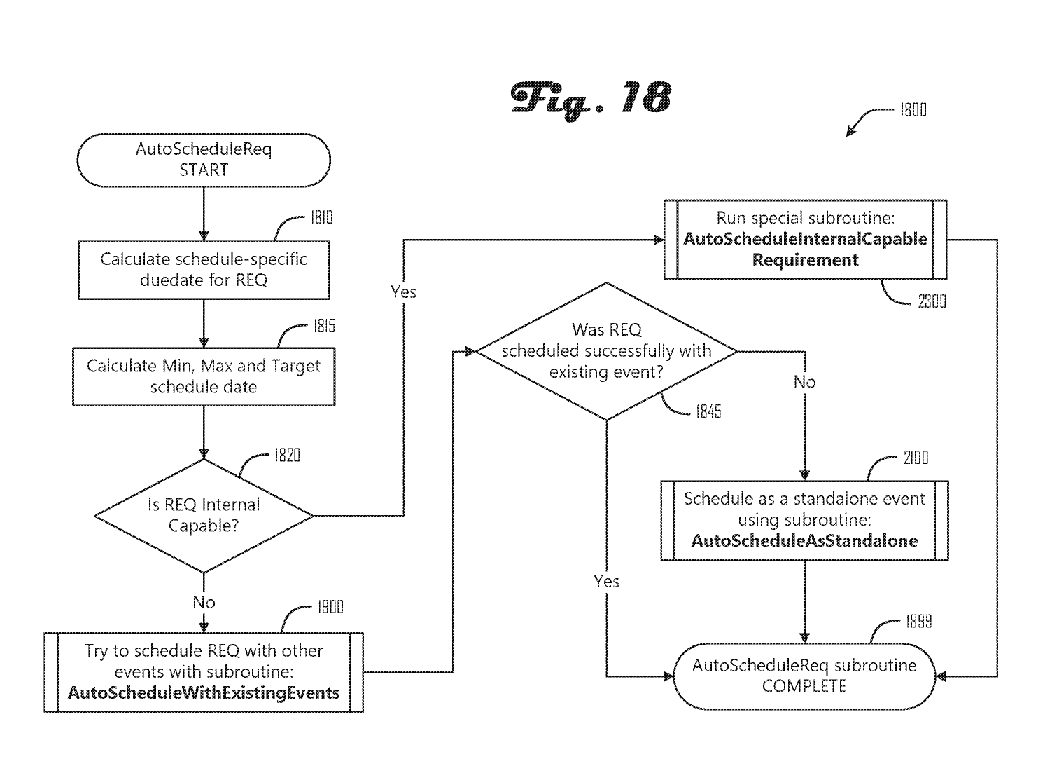

FIG. 18 illustrates an automatic or semi-automatic subroutine 1800 suitable for use with at least one embodiment.

Following a start operation, execution block 1810 depicts calculating a schedule-specific duedate for a taskset.

Execution block 1815 depicts calculating minimum, maximum, and target schedule dates (as a component of yields as described above with reference to FIG. 2, e.g.).

At decision block 1820, the taskset is capable of being performed internally (by an airline or fleet owner, e.g.), execution proceeds to subroutine 2300 and then ends at block 1899. Otherwise execution proceeds to subroutine 1900 and then to decision block 1845.

At decision block 1845, if the taskset was allocated successfully with an existing event then execution ends at block 1899. Otherwise execution then proceeds to subroutine 2100 and then ends at block 1899.

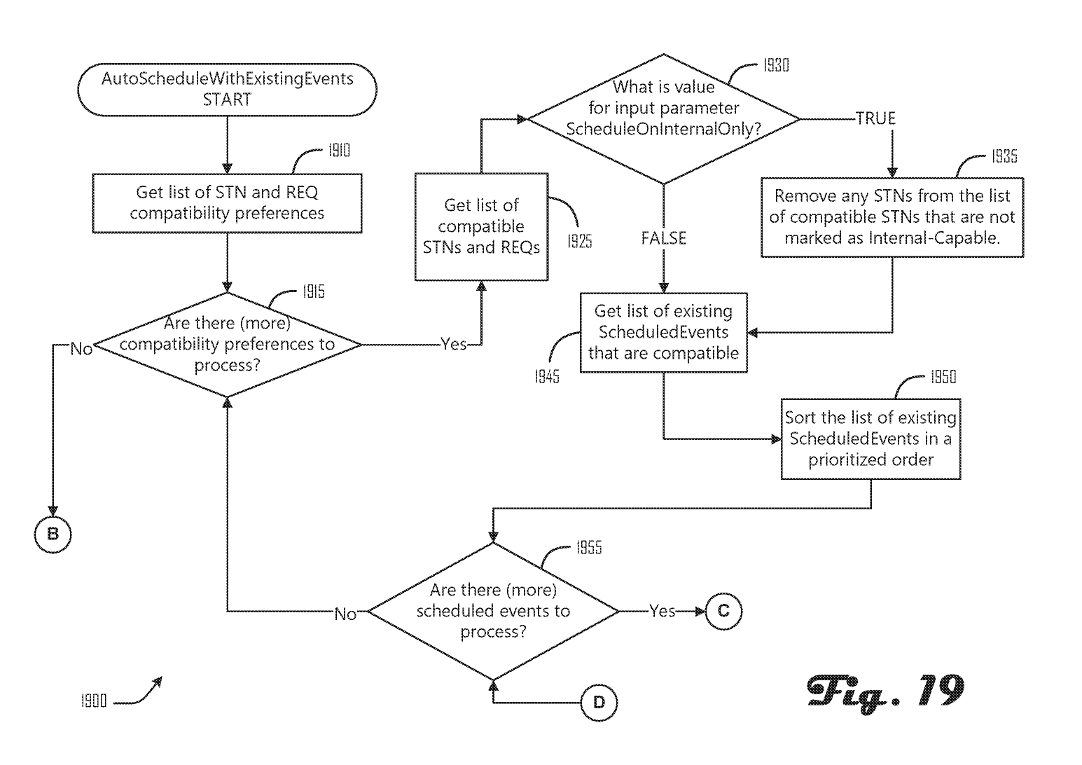

FIG. 19 illustrates an automatic or semi-automatic subroutine 1900 suitable for use with at least one embodiment.

Following a start operation, execution block 1910 depicts getting a list of facility/station and taskset compatibility preferences.

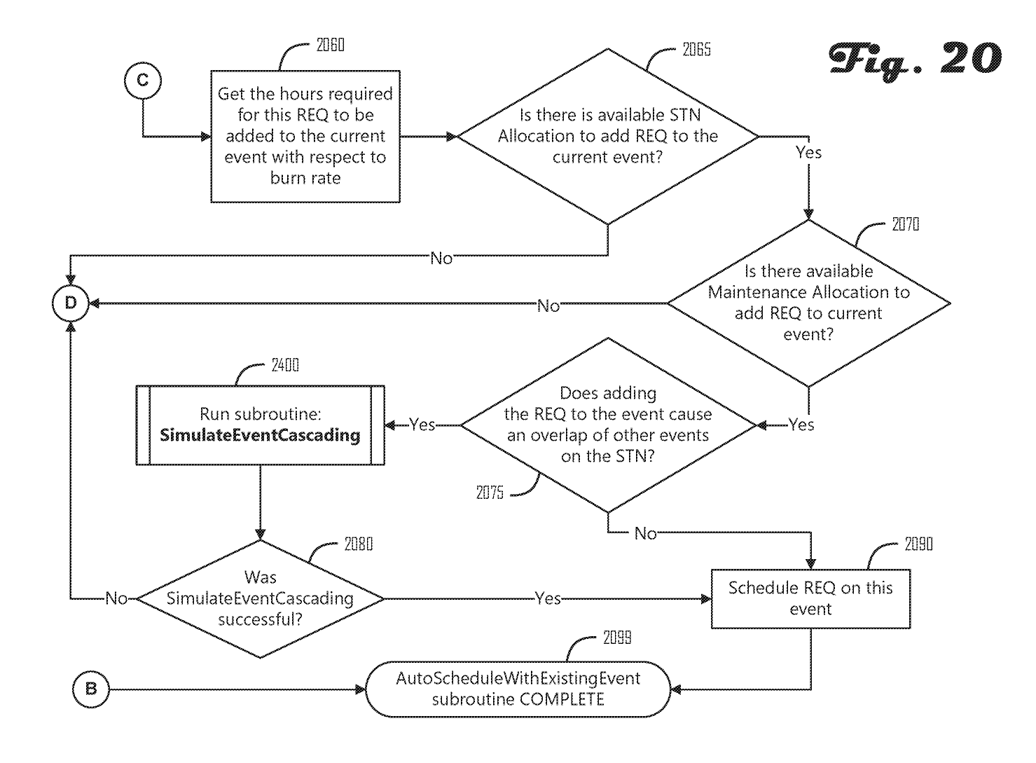

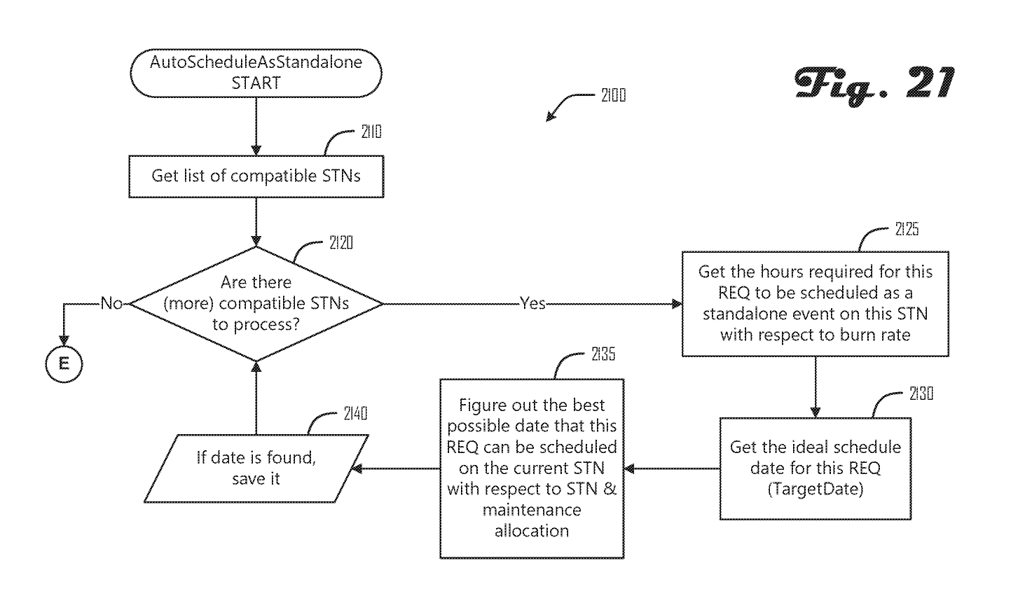

At decision block 1915, if there are more compatibility preferences to process, execution proceeds to execution block 1925. Otherwise execution proceeds to waypoint “B” (continued at FIG. 20).

Execution block 1925 depicts getting a list of compatible facilities/stations and tasksets.

At decision block 1930, a determination is made concerning a Boolean variable. If the variable is true, execution block proceeds to remove any facilities/stations from the list that are not marked as compatible with a preferred facility or mode of performance (able to be performed at a vehicle-owner-operated or other preferable facility/station, e.g.). In either case execution then proceeds to execution block 1945.

Execution block 1945 depicts getting a list 320 of scheduled events that are compatible (with scheduler-expressed allocation preferences, e.g.).

At execution block 1950, the list 320 is sorted into a prioritized order.

At decision block 1955, a determination is made whether any events/records remain to process/schedule. If so execution proceeds to waypoint “C” and otherwise back to decision block 1915.

FIG. 20 illustrates an extension of automatic or semi-automatic subroutine 1900 continuing from any of several waypoints (continued from FIG. 19).

From waypoint “B” execution ends at block 2099.

From waypoint “C” execution proceeds to block 2060 at which the hours to be added to the allocation/event by virtue of burn rate as described above are taken into account.

At decision block 2065 a determination is made whether there is adequate facility/station capacity so as to allow the taskset to be merged to a current event (as exemplified above with reference to FIG. 17, e.g.). If not then execution proceeds to waypoint “D.” But if there is such adequate facility/station capacity then execution proceeds to decision block 2075.

At decision block 2075 a determination is made whether merging the taskset with the identified allocation would trigger an overlap with other scheduled events/allocations at the facility/station. If so then subroutine 2400 is invoked and execution then passes to decision block 2080. But if such merging would not trigger any such overlap then (at block 2090) the taskset is merged and execution ends at block 2099.

At decision block 2080 a determination is made whether subroutine 2400 was successful. If so then (at block 2090) the taskset is merged and execution ends at block 2099. But if subroutine 2400 was not successful then execution proceeds to waypoint “D.”

From waypoint “D” execution proceeds back to decision block 1955.

At block 2099 subroutine 1900 returns TRUE if a taskset/requirement was scheduled and FALSE otherwise.

FIG. 21 illustrates an automatic or semi-automatic subroutine 2100 suitable for use with at least one embodiment.

Following a start operation, execution block 2110 depicts getting a list of facilities/stations together with an indication of which vehicles/tasksets are compatible.

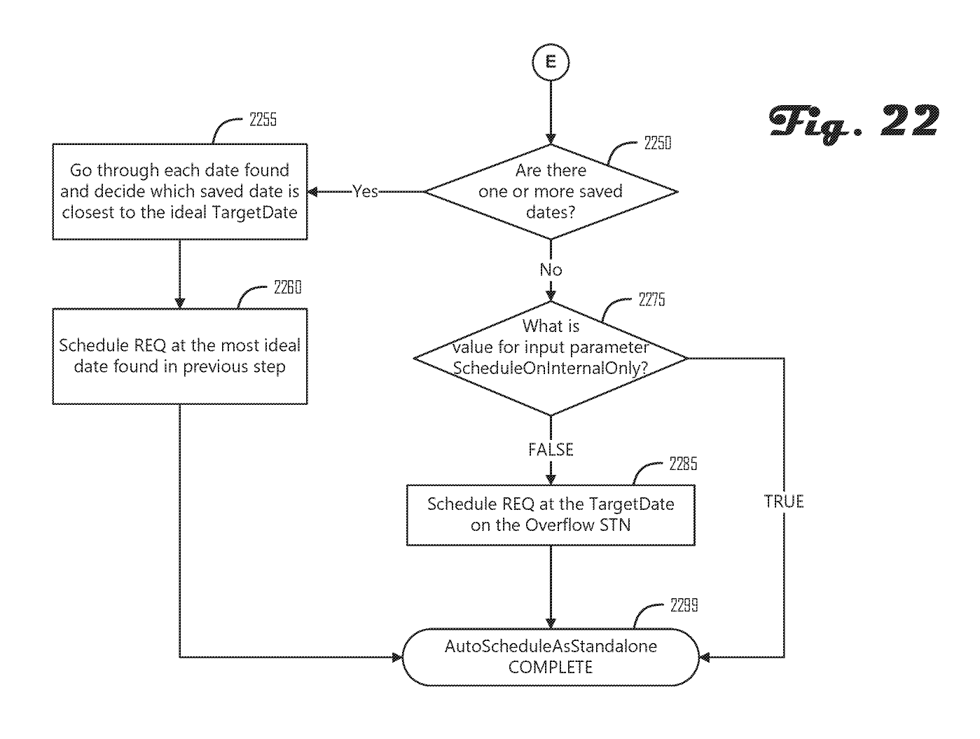

At decision block 2120, if there are more facilities/stations to process, execution proceeds to execution block 2125. Otherwise execution proceeds to waypoint “E” (continued at FIG. 22).

Execution block 2125 depicts receiving/generating a list of the hours required for the current taskset to be scheduled as a standalone event/allocation at this facility/station with respect to burn rate 125.

Execution block 2130 depicts receiving/generating an ideal/target schedule date for the current taskset without regard to present allocation of any facility/station under consideration.

Execution block 2135 depicts receiving/generating an ideal/target schedule date for the current taskset with regard to present allocation of a facility/station under consideration.

Block 2140 depicts reserving/allocating the current facility/station at the current date for the current taskset to be performed upon the present vehicle and saving that allocation as a candidate for further consideration.

FIG. 22 illustrates an extension of automatic or semi-automatic subroutine 2100 continuing from waypoint “E” (continued from FIG. 21).

At decision block 2275 a determination is made whether any candidate dates were identified/saved. If so execution passes to block 2255. If not then (at decision block 2275) if the “ScheduleOnInternalOnly” parameter was set to TRUE then execution ends at block 2299. But if that parameter was set to FALSE then execution proceeds to block 2285.

Execution block 2255 depicts determining which date of the candidate allocations is most ideal, closest to the schedule date obtained at execution block 2130, after which (at block 2260) the taskset is scheduled at that most ideal date and execution ends at block 2299.

Execution block 2285 depicts scheduling the current taskset/requirement on a virtual/overflow facility/station, after which execution ends at block 2299.

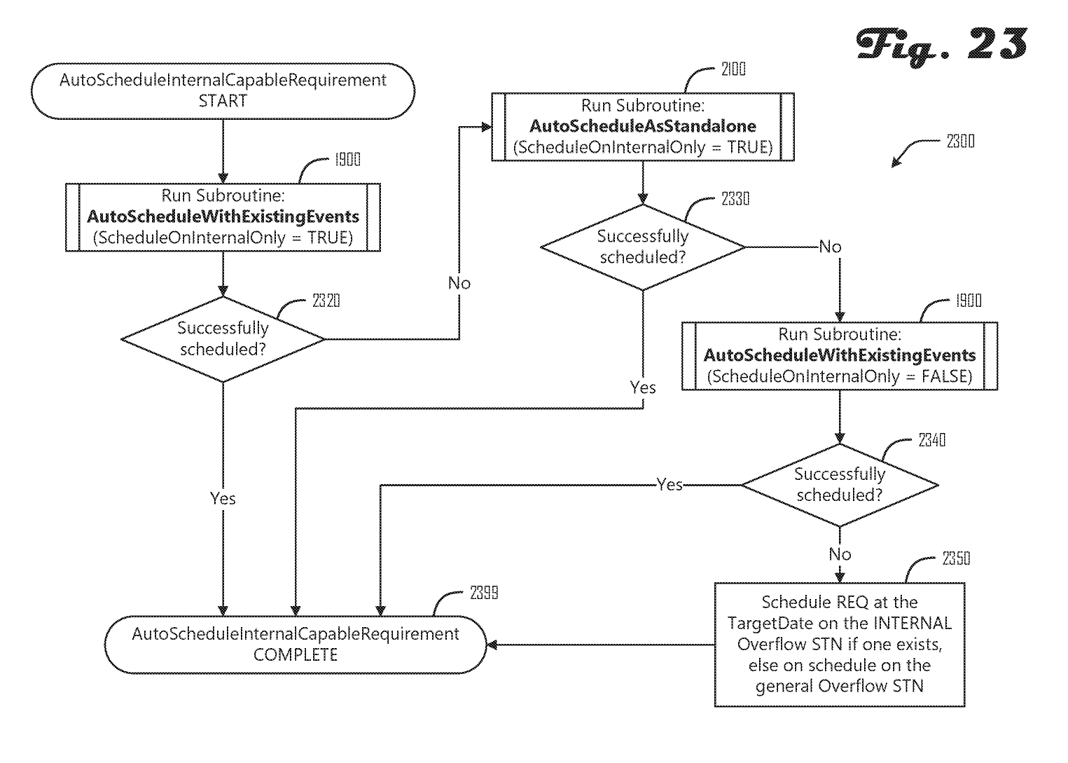

FIG. 23 illustrates an automatic or semi-automatic subroutine 2300 suitable for use with at least one embodiment.

Following a start operation, subroutine 1900 is invoked with the above-mentioned “on internal only” parameter set to TRUE.

At decision block 2320, if said invocation of subroutine 1900 was successful then execution ends at block 2399. Otherwise execution proceeds to an invocation of subroutine 2100 with the above-mentioned “on internal only” parameter set to TRUE.

At decision block 2330, if said invocation of subroutine 2100 was successful then execution ends at block 2399. Otherwise execution proceeds to an invocation of subroutine 1900 with the above-mentioned “on internal only” parameter set to FALSE.

At decision block 2340, if said invocation of subroutine 1900 was unsuccessful then (at block 2350) the taskset is scheduled at the current target date on a virtual/overflow facility/station (on an overflow station designated as internal if one exists). In either case, execution then ends at block 2399.

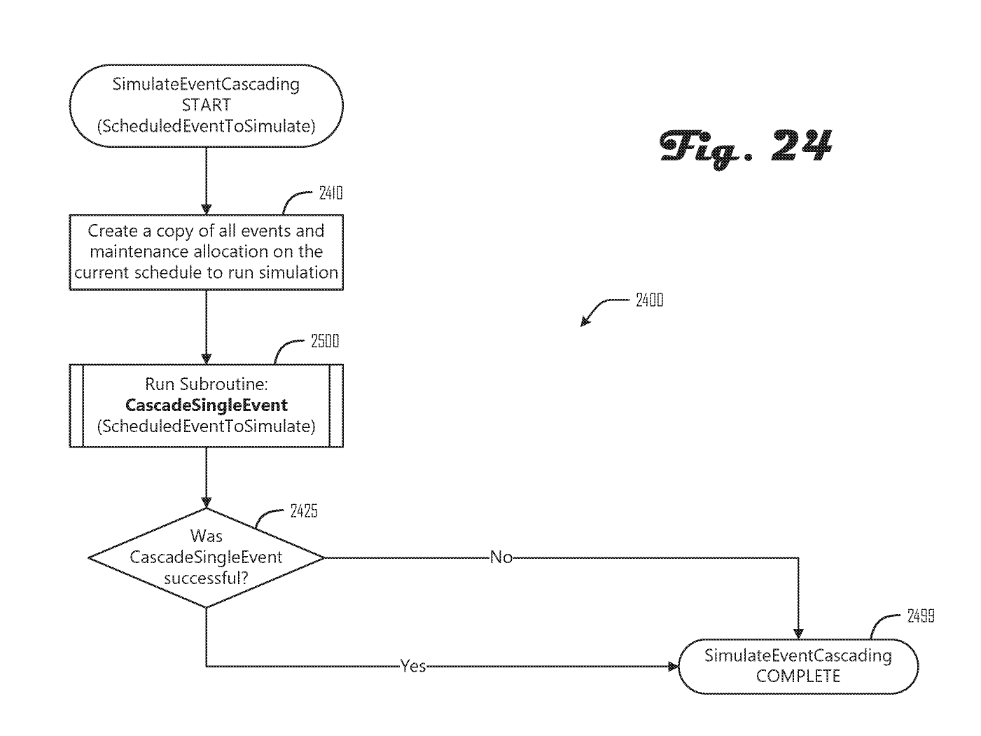

FIG. 24 illustrates an automatic or semi-automatic subroutine 2400 suitable for use with at least one embodiment.

Following a start operation, execution block 2410 depicts creating a copy of all events and maintenance allocations on the current schedule in preparation for running a simulation.

Subroutine 2500 is then invoked with the allocation/event to schedule passed as a parameter.

At decision block 2425, if said invocation of subroutine 2500 was successful then the simulation ends at block 2499, returning a success-indicative value for use at decision block 2080. Otherwise the simulation ends at block 2499, returning a failure-indicative value for use at decision block 2080.

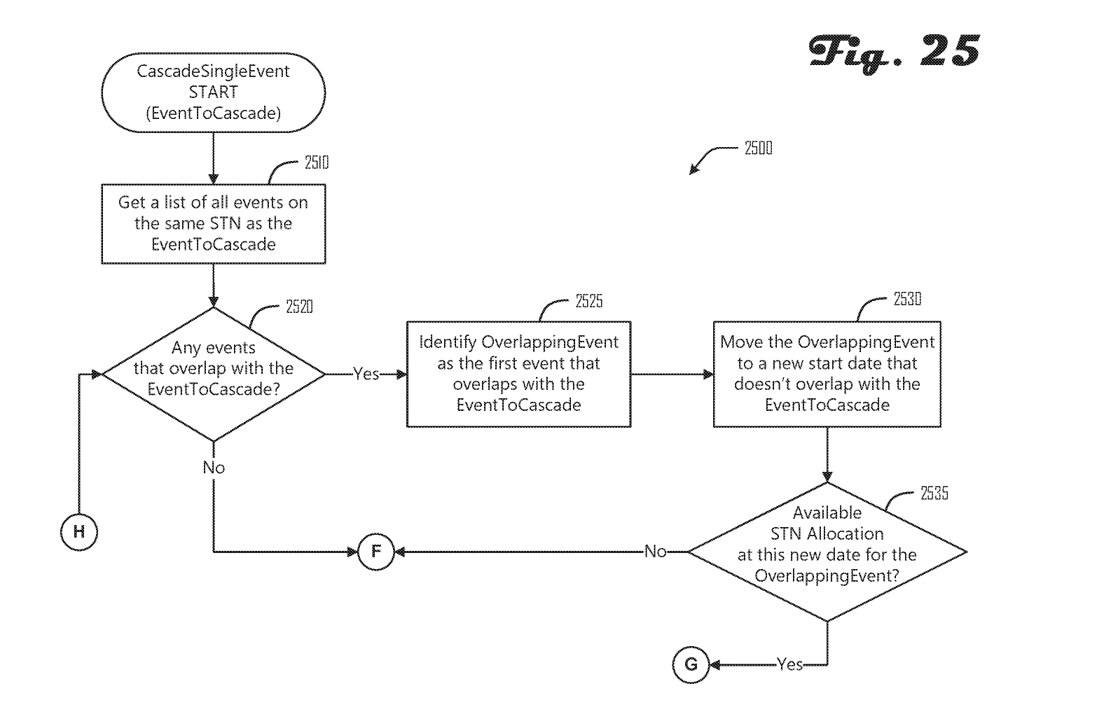

FIG. 25 illustrates an automatic or semi-automatic subroutine 2500 suitable for use with at least one embodiment, one in which an allocation/event to schedule is received as a parameter.

Following a start operation, execution block 2510 depicts getting a list of already-scheduled events/allocations at the same facility/station as the allocation/event received as a parameter.

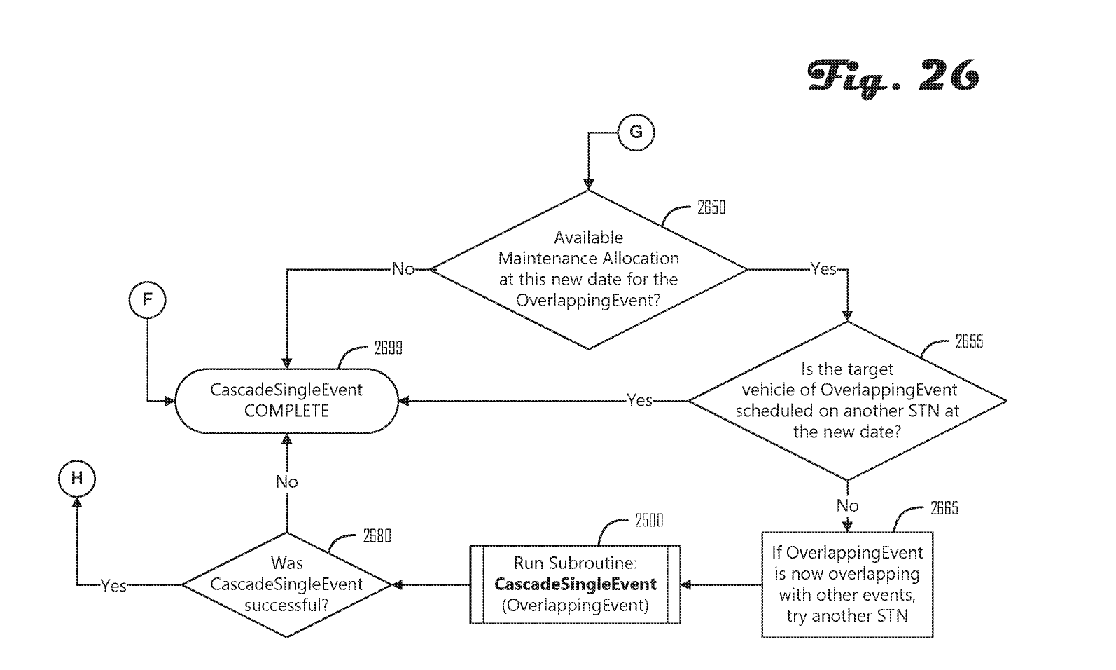

At decision block 2520, if there are any events that overlap with the allocation/event received as a parameter then execution proceeds to block 2525. Otherwise execution proceeds to waypoint “F” (continued at FIG. 26).

Execution block 2525 depicts identifying an overlapping event/allocation as the first event that overlaps with the allocation/event received as a parameter.

Execution block 2530 depicts moving/rescheduling the overlapping event/allocation to a new start date/time that does not overlap with the allocation/event received as a parameter.

At decision block 2535 a determination is made whether any (real) facility/station is available at the new start date/time for the overlapping event/allocation. If so then execution proceeds to waypoint “G” but if not then execution proceeds to waypoint “F” (both continued at FIG. 26).

FIG. 26 illustrates an extension of automatic or semi-automatic subroutine 2500 continuing from waypoint “F” or “G” (continued from FIG. 25).

From waypoint “F” execution simply ends at block 2699.

From waypoint “G” (at decision block 2650) a determination is made whether any allocation is available at the new start date/time. If not then execution ends at block 2699.

Otherwise (at decision block 2655) a determination is made whether the target vehicle is scheduled to be at any other facility/station at the new date. If so then execution ends at block 2699.

Otherwise (at execution block 2665) an effort to try another station is initiated if the overlapping event is itself overlapping with other events. For example an invocation of subroutine 2500 is made with the overlapping event as a passed parameter/argument, a recursive invocation. If that invocation is successful then execution proceeds (via waypoint “H”) back to decision block 2520. Otherwise execution ends at block 2699. Alternatively or additionally, block 2665 may comprise an effort to rearrange taskset allocations pertaining to the current facility/station (by rearranging and evaluating every possible sequence of tasksets scheduled there, e.g.) in response to such overlap being detected.

In light of teachings herein, numerous existing techniques may be applied for configuring special-purpose circuitry or other structures effective for configuring a server to respond to an automatically detected event (by making a data association, e.g.) or other tasks as described herein without undue experimentation. See, e.g., U.S. Pat. No. 9,552,271 (“Enhanced dispatch for integrated modular avionics solutions system and related method”); U.S. Pat. No. 9,491,581 (“Location based services onboard aircraft”); U.S. Pat. No. 9,475,590 (“Method of implementing a maintenance schedule for an aircraft and a maintenance system”); U.S. Pat. No. 9,424,693 (“Maintenance planning optimization for repairable items based on prognostics and health monitoring data”); U.S. Pat. No. 9,400,960 (“Methods for verifying satisfaction of prognostic algorithm requirements for a component having multiple failure modes”); U.S. Pat. No. 9,317,829 (“Diagnosing incidents for information technology service management”); U.S. Pat. No. 9,311,611 (“Automated service level management system”); U.S. Pat. No. 9,251,502 (“Maintenance system for aircraft fleet and method for planning maintenance”); U.S. Pat. No. 9,153,138 (“Agent-based airfield conflict resolution”); U.S. Pat. No. 9,037,320 (“Unscheduled maintenance disruption severity and flight decision system and method”); and “Basics of Aircraft Maintenance Programs for Financiers” and “The Relationship between an Aircraft's Value and its Maintenance Status” both by Mr. Shannon Ackert. These documents are incorporated herein by reference to the extent not inconsistent herewith.

With respect to the numbered clauses and claims expressed below, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise. Also in the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

### CLAUSES

1. (Independent) A vehicle maintenance scheduling system comprising: transistor-based circuitry configured to obtain a first maximum yield 263C, a first primary target yield 262C, and a first minimum yield 261C all in association with a first vehicle maintenance taskset (“REQ1,” e.g.) that pertains to a first vehicle 158 (“A100” or “A101,” e.g.);

transistor-based circuitry configured to obtain a second maximum yield 263D, a second primary target yield 262D, and a second minimum yield 261D all in association with a second vehicle maintenance taskset (“REQ2,” e.g.) that pertains to a second vehicle 158 (“A101” or “A100,” e.g.);

transistor-based circuitry configured to obtain a third maximum yield, a third primary target yield, and a third minimum yield all in association with a third vehicle maintenance taskset (“REQ3,” e.g.) that pertains to both the first and second vehicles;

transistor-based circuitry configured to manifest the third primary target yield automatically with a first preliminary allocation selectively among a first maintenance facility (“XY21,” e.g.), the third vehicle maintenance taskset, and the first vehicle as a conditional response (at least) to a facility-to-taskset compatibility (conditioned upon a facility-to-taskset compatibility index 606 of “LOW” or better, e.g.) at least between the first maintenance facility (“XY21,” e.g.) and the third vehicle maintenance taskset and to a facility-to-vehicle compatibility (conditioned upon a facility-to-vehicle compatibility index 406 of “LOW” or better, e.g.) at least between the first maintenance facility (“XY21,” e.g.) and the first vehicle;

transistor-based circuitry configured to manifest the third primary target yield automatically invoking transistor-based circuitry configured to manifest the third primary target yield with a first preliminary allocation selectively among a first maintenance facility (“XY21,” e.g.), the third vehicle maintenance taskset, and the first vehicle as a conditional response (at least) to a facility-to-taskset compatibility (conditioned upon a facility-to-taskset compatibility index 606 of “LOW” or better, e.g.) at least between the first maintenance facility (“XY21,” e.g.) and the third vehicle maintenance taskset and to a facility-to-vehicle compatibility (conditioned upon a facility-to-vehicle compatibility index 406 of “LOW” or better, e.g.) at least between the first maintenance facility (“XY21,” e.g.) and the first vehicle;

transistor-based circuitry configured to manifest the third primary target yield again with a second preliminary allocation selectively among a second maintenance facility (“XY22,” e.g.), the third vehicle maintenance taskset, and the second vehicle as a conditional response (at least) to a facility-to-vehicle compatibility (as a response to a facility-to-vehicle compatibility index 406 of “LOW” or better, e.g.) at least between the second maintenance facility (“XY22,” e.g.) and the second vehicle and to a facility-to-taskset compatibility (as a response to a facility-to-taskset compatibility index 606 of “LOW” or better, e.g.) at least between the second maintenance facility (“XY22,” e.g.) and the third vehicle maintenance taskset;

transistor-based circuitry configured to manifest an other preliminary allocation automatically and selectively at least between the first maintenance facility (“XY21,” e.g.) and the first vehicle (and with a taskset identified as “REQ1” or “REQ2” or “REQ4” at a corresponding primary target yield 262, e.g.) after the first and second preliminary allocations as a conditional response (at least) to a taskset-to-taskset compatibility (as a response to a taskset-to-taskset compatibility index 506 of “LOW” or better, e.g.) at least between the second vehicle maintenance taskset and the third vehicle maintenance taskset and to a facility-to-taskset compatibility (conditioned upon a facility-to-taskset compatibility index 606 of “LOW” or better, e.g.) at least between the first maintenance facility (“XY21,” e.g.) and the second vehicle maintenance taskset and to a facility-to-vehicle compatibility (as a response to a facility-to-vehicle compatibility index 406 of “LOW” or better, e.g.) at least between the first maintenance facility (“XY21,” e.g.) and the first vehicle; and

transistor-based circuitry configured to transmit a first expression 1105 of a first final schedule (e.g. module 1026B disseminating a complete schedule or component allocations 990 thereof) remotely to a first special-purpose device (to a station 120, vehicle 158, or special-purpose client device 700 across a distance of more than a mile, e.g.) as a conditional response to a first Boolean adequacy determination (received as a user validation or as an automatically detected indication of success, e.g.) signifying that some or all (two or more, e.g.) of the preliminary allocations collectively constitute the first final schedule.

2. The system of any of the above SYSTEM CLAUSES, further comprising:

said first vehicle, wherein the first vehicle comprises the first special-purpose device.

3. The system of any of the above SYSTEM CLAUSES, further comprising:

said first maintenance facility, wherein the first maintenance facility comprises the first special-purpose device.

4. The system of any of the above SYSTEM CLAUSES, wherein the first maintenance facility is a station configured to contain the first vehicle.

5. The system of any of the above SYSTEM CLAUSES, further comprising the first and second vehicles.

6. The system of any of the above SYSTEM CLAUSES, wherein the first vehicle is a cargo plane and the second vehicle is a passenger airplane.

7. The system of any of the above SYSTEM CLAUSES, wherein the system is configured to perform one of the METHOD CLAUSES set forth herein.

8. (Independent) A vehicle maintenance scheduling method comprising:

invoking transistor-based circuitry configured to obtain a first maximum yield 263, a first primary target yield 262, and a first minimum yield 261 all in association with a first vehicle maintenance taskset (“REQ1,” e.g.) that pertains to a first vehicle 158 (“A100” or “A101,” e.g.);

invoking transistor-based circuitry configured to obtain a second maximum yield 263, a second primary target yield 262, and a second minimum yield 261 all in association with a second vehicle maintenance taskset (“REQ2,” e.g.) that pertains to a second vehicle 158 (“A101” or “A100,” e.g.);

invoking transistor-based circuitry configured to obtain a third maximum yield 263, a third primary target yield 262, and a third minimum yield 261 all in association with a third vehicle maintenance taskset (“REQ3,” e.g.) that pertains to both the first and second vehicles;

automatically invoking transistor-based circuitry configured to manifest the third primary target yield with a first preliminary allocation selectively among a first maintenance facility (“XY21,” e.g.), the third vehicle maintenance taskset, and the first vehicle as a conditional response (at least) to a facility-to-taskset compatibility (conditioned upon a facility-to-taskset compatibility index 606 of “LOW” or better, e.g.) at least between the first maintenance facility (“XY21,” e.g.) and the third vehicle maintenance taskset and to a facility-to-vehicle compatibility (conditioned upon a facility-to-vehicle compatibility index 406 of “LOW” or better, e.g.) at least between the first maintenance facility (“XY21,” e.g.) and the first vehicle;

automatically invoking transistor-based circuitry configured to manifest the third primary target yield again with a second preliminary allocation selectively among a second maintenance facility (“XY22,” e.g.), the third vehicle maintenance taskset, and the second vehicle as a conditional response (at least) to a facility-to-vehicle compatibility (as a response to a facility-to-vehicle compatibility index 406 of “LOW” or better, e.g.) at least between the second maintenance facility (“XY22,” e.g.) and the second vehicle and to a facility-to-taskset compatibility (as a response to a facility-to-taskset compatibility index 606 of “LOW” or better, e.g.) at least between the second maintenance facility (“XY22,” e.g.) and the third vehicle maintenance taskset;

automatically invoking transistor-based circuitry configured to manifest an other preliminary allocation selectively at least between the first maintenance facility (“XY21,” e.g.) and the first vehicle (and with a taskset identified as “REQ1” or “REQ2” or “REQ4” at a corresponding primary target yield 262, e.g.) after the first and second preliminary allocations as a conditional response (at least) to a taskset-to-taskset compatibility (as a response to a taskset-to-taskset compatibility index 506 of “LOW” or better, e.g.) at least between the second vehicle maintenance taskset and the third vehicle maintenance taskset and to a facility-to-taskset compatibility (conditioned upon a facility-to-taskset compatibility index 606 of “LOW” or better, e.g.) at least between the first maintenance facility (“XY21,” e.g.) and the second vehicle maintenance taskset and to a facility-to-vehicle compatibility (as a response to a facility-to-vehicle compatibility index 406 of “LOW” or better, e.g.) at least between the first maintenance facility (“XY21,” e.g.) and the first vehicle; and invoking transistor-based circuitry configured to transmit (at least) a first expression 1105 of a first final schedule (e.g. module 1026B disseminating a final schedule or one or more component allocations 990 thereof) remotely to a first special-purpose device (to a station 120, vehicle 158, or special-purpose client device 700 across a distance of more than a mile, e.g.) as a conditional response to a first Boolean adequacy determination (manifested as a voltage configuration 1046B on an electrical node set 1036B, e.g.) signifying that some or all (two or more, e.g.) of the preliminary allocations collectively constitute the first final schedule (as authorized by a user or as an automatic response to an error-free implementation, e.g.).

9. The method of METHOD CLAUSE 8, wherein the other preliminary allocation manifests the first primary target yield and selectively associates the first maintenance facility (“XY21,” e.g.) and the first vehicle both with the first vehicle maintenance taskset (identified as “REQ1,” e.g.).

10. The method of METHOD CLAUSE 8, wherein the other preliminary allocation manifests the second primary target yield and selectively associates the first maintenance facility (“XY21,” e.g.) and the first vehicle both with the second vehicle maintenance taskset (identified as “REQ2,” e.g.).

11. The method of METHOD CLAUSE 8, wherein the other preliminary allocation manifests a fourth primary target yield and selectively associates the first maintenance facility (“XY21,” e.g.) and the first vehicle both with a fourth vehicle maintenance taskset (identified as “REQ4,” e.g.).

12. The method of any of the above METHOD CLAUSES, further comprising:

obtaining first, second, and third secondary target yields each in association with a respective one of the vehicle maintenance tasksets.

13. The method of any of the above METHOD CLAUSES, wherein the first primary target yield is temporally closer to the first maximum yield than to the first minimum yield, wherein the second primary target yield is temporally closer to the second maximum yield than to the second minimum yield, and wherein the third primary target yield is temporally closer to the third maximum yield than to the third minimum yield.

14. The method of any of the above METHOD CLAUSES, wherein the first primary target yield is in a middle half of a first time interval between the maximum yield and the first minimum yield, wherein the second primary target yield is in a middle half of a second time interval between the maximum yield and the second minimum yield, and wherein the third primary target yield is in a middle half of a third time interval between the maximum yield and the third minimum yield.

15. The method of any of the above METHOD CLAUSES, wherein the automatically invoking transistor-based circuitry configured to manifest the other preliminary allocation selectively at least between the first maintenance facility and the first vehicle after the first and second preliminary allocations as the conditional response comprises:
invoking the conditional response upon a determination that the third vehicle maintenance taskset has a prioritization (designated as “Tier 1” or “T1” in a taskset list 320, e.g.) higher than a prioritization of the other preliminary allocation (designated as “Tier 2” or lower, e.g.).

16. The method of any of the above METHOD CLAUSES, wherein the automatically invoking transistor-based circuitry configured to manifest the other preliminary allocation selectively at least between the first maintenance facility and the first vehicle after the first and second preliminary allocations as the conditional response comprises:
invoking the conditional response upon a determination that the first and second preliminary allocations have a shared prioritization higher than a prioritization of the other preliminary allocation.

17. The method of any of the above METHOD CLAUSES, wherein sad automatically invoking transistor-based circuitry configured to manifest said third primary target yield with said first preliminary allocation comprises:
automatically deciding which among said vehicle maintenance tasksets having a shared prioritization to allocate first as a conditional response to a difference of a degree of facility-to-vehicle compatibility among said vehicle maintenance tasksets having a shared prioritization (scheduling a taskset associated with a “HIGH” facility-to-vehicle compatibility index 406 in relation to a station 120 with which the taskset is potentially allocated and to a vehicle 158 with which the taskset is potentially allocated before one having a “MEDIUM” or “LOW” facility-to-vehicle compatibility index 406, e.g.).

18. The method of any of the above METHOD CLAUSES, wherein sad automatically invoking transistor-based circuitry configured to manifest said third primary target yield with said first preliminary allocation comprises:
automatically deciding which among said vehicle maintenance tasksets having a shared prioritization to allocate first as a conditional response to a difference of a degree of taskset-to-taskset compatibility among said vehicle maintenance tasksets having a shared prioritization (scheduling a taskset associated with a “HIGH” taskset-to-taskset compatibility index 506 in relation to a potentially concurrently performed taskset before one having a “MEDIUM” or “LOW” taskset-to-taskset compatibility index 506, e.g.).

19. The method of any of the above METHOD CLAUSES, wherein sad automatically invoking transistor-based circuitry configured to manifest said third primary target yield with said first preliminary allocation comprises:
automatically deciding which among said vehicle maintenance tasksets having a shared prioritization to allocate first as a conditional response to a difference of a degree of facility-to-taskset compatibility among said vehicle maintenance tasksets having a shared prioritization (scheduling a taskset associated with a “HIGH” facility-to-taskset compatibility index 606 in relation to a station 120 to which the taskset is potentially allocated before one having a “MEDIUM” or “LOW” facility-to-taskset compatibility index 606, e.g.).

20. The method of any of the above METHOD CLAUSES, wherein the automatically invoking transistor-based circuitry configured to manifest the other preliminary allocation selectively at least between the first maintenance facility and the first vehicle after the first and second preliminary allocations as the conditional response comprises:
determining that the second vehicle maintenance taskset (“REQ2,” e.g.) has an intermediate prioritization relative to a higher and a lower prioritization, wherein the first vehicle maintenance taskset (“REQ1,” e.g.) has the lower prioritization and the third vehicle maintenance taskset (“REQ3,” e.g.) has the higher prioritization.

21. The method of any of the above METHOD CLAUSES, wherein the method includes all of the operations depicted in FIG. 9 as being performed at server 800.

22. The method of any of the above METHOD CLAUSES, wherein the invoking transistor-based circuitry configured to transmit the first expression 1105 of the first final schedule remotely to the first special-purpose device comprises:
graphically presenting an allocation start time index 1171, a taskset start time index 1172, a taskset end time index 1173, and an allocation end time index 1174 all as components of the first expression simultaneously manifested each as a transition between a lighter shade and a darker shade on a display screen of the first special-purpose device.

23. The method of any of the above METHOD CLAUSES, further comprising: obtaining a just-revised taskset list 320B (i.e. changed less than one hour prior) that contains the first, second, and third vehicle maintenance tasksets and also contains dozens of additional vehicle maintenance tasksets (i.e. at least 24) that each pertains to one or more other vehicles 158 (including an aircraft identified as “A102” in one or more just-provided or just-changed records 1521 and other aircraft of the same fleet, e.g.) and that each determines a respective maximum yield 263, a respective primary target yield 262, and a respective minimum yield 261;

processing a majority (i.e. more than 50% but less than all) of the additional vehicle maintenance tasksets after the first expression of the first final schedule by manifesting a corresponding additional preliminary allocation selectively as a conditional response to a corresponding taskset-to-taskset compatibility (as a response to a taskset-to-taskset compatibility index 506 of “LOW” or better, e.g.) and to a corresponding facility-to-taskset compatibility (conditioned upon a facility-to-taskset compatibility index 606 of “LOW” or better, e.g.) and to a corresponding facility-to-vehicle compatibility (as a response to a facility-to-vehicle compatibility index 406 of “LOW” or better, e.g.) into a second final schedule; and transmitting a first expression of the second final schedule remotely to the first special-purpose device as a real-time response (i.e. within ten minutes) to the obtaining the just-revised taskset list 320 and as a conditional response to a second Boolean determination signifying that some of the corresponding additional preliminary allocations collectively constitute the second final schedule.

24. The method of any of the above METHOD CLAUSES, further comprising:

obtaining a just-revised taskset list that contains the first, second, and third vehicle maintenance tasksets and also contains hundreds of additional vehicle maintenance tasksets that each pertains to one or more other vehicles 158 and that each determines a respective maximum yield 263, a respective primary target yield 262, and a respective minimum yield 261;

processing a majority of the additional vehicle maintenance tasksets after the first expression of the first final schedule by manifesting a corresponding additional preliminary allocation selectively as a conditional response to a corresponding taskset-to-taskset compatibility and to a corresponding facility-to-taskset compatibility and to a corresponding facility-to-vehicle compatibility into a second final schedule; and

transmitting a first expression of the second final schedule remotely to the first special-purpose device as a real-time response (i.e. within ten minutes) to the obtaining the just-revised taskset list 320 and as a conditional response to a second Boolean determination signifying that (at least) some of the corresponding additional preliminary allocations (i.e. two or more) collectively constitute the second final schedule.

25. The method of any of the above METHOD CLAUSES, wherein the first expression of a most recent final schedule depicts at least ten successive projects (taskset groups each performed upon a respective vehicle, e.g.) collectively spanning more than one year at the first maintenance facility.

While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

What is claimed is:

1. A vehicle maintenance scheduling method comprising:
invoking transistor-based circuitry configured to obtain a first maximum yield, a first primary target yield, and a first minimum yield all in association with a first vehicle maintenance taskset that pertains to a first vehicle;
invoking transistor-based circuitry configured to obtain a second maximum yield, a second primary target yield, and a second minimum yield all in association with a second vehicle maintenance taskset that pertains to a second vehicle;
invoking transistor-based circuitry configured to obtain a third maximum yield, a third primary target yield, and a third minimum yield all in association with a third vehicle maintenance taskset that pertains to both said first and second vehicles;
automatically invoking transistor-based circuitry configured to manifest said third primary target yield with a first preliminary allocation selectively among a first maintenance facility, said third vehicle maintenance taskset, and said first vehicle as a conditional response to a facility-to-taskset compatibility between said first maintenance facility and said third vehicle maintenance taskset and to a facility-to-vehicle compatibility between said first maintenance facility and said first vehicle;
automatically invoking transistor-based circuitry configured to manifest said third primary target yield again with a second preliminary allocation selectively among a second maintenance facility, said third vehicle maintenance taskset, and said second vehicle as a conditional response to a facility-to-vehicle compatibility between said second maintenance facility and said second vehicle and to a facility-to-taskset compatibility between said second maintenance facility and said third vehicle maintenance taskset;
automatically invoking transistor-based circuitry configured to manifest an other preliminary allocation selectively at least between said first maintenance facility and said first vehicle after said first and second preliminary allocations as a conditional response to said third vehicle maintenance taskset having a prioritization higher than a prioritization of said other preliminary allocation and to a taskset-to-taskset compatibility between said second vehicle maintenance taskset and said third vehicle maintenance taskset and to a facility-to-taskset compatibility between said first maintenance facility and said second vehicle maintenance taskset and to a facility-to-vehicle compatibility between said first maintenance facility and said first vehicle;
transmitting a first expression of a first final schedule remotely to a first special-purpose device as a conditional response to a first Boolean determination signifying that two or more of said preliminary allocations collectively constitute said first final schedule, wherein said first special-purpose device is said first vehicle;
obtaining a just-revised taskset list that contains said first, second, and third vehicle maintenance tasksets and also contains hundreds of additional vehicle maintenance tasksets that each pertains to one or more other vehicles and that each determines a respective maximum yield, a respective primary target yield, and a respective minimum yield;
processing a majority of said additional vehicle maintenance tasksets after said first expression of said first final schedule by manifesting a corresponding additional preliminary allocation selectively as a conditional response to a corresponding taskset-to-taskset compatibility and to a corresponding facility-to-taskset compatibility and to a corresponding facility-to-vehicle compatibility into a second final schedule; and
transmitting a first expression of said second final schedule remotely to said first special-purpose device as a real-time response to said obtaining said just-revised taskset list and as a conditional response to a second Boolean determination signifying that some of said corresponding additional preliminary allocations collectively constitute said second final schedule.

2. The vehicle maintenance scheduling method of claim 1, wherein said first expression of said second final schedule depicts at least ten successive projects spanning more than one year at said first maintenance facility and wherein each of said successive projects is performed upon a respective vehicle of a fleet that includes said first and second and other vehicles.

3. The vehicle maintenance scheduling method of claim 1, wherein said first primary target yield is temporally closer to said first maximum yield than to said first minimum yield, wherein said second primary target yield is temporally closer to said second maximum yield than to said second minimum yield, and wherein said third primary target yield is temporally closer to said third maximum yield than to said third minimum yield.

4. A vehicle maintenance scheduling method comprising:
invoking transistor-based circuitry configured to obtain a first maximum yield, a first primary target yield, and a first minimum yield all in association with a first vehicle maintenance taskset that pertains to a first vehicle;
invoking transistor-based circuitry configured to obtain a second maximum yield, a second primary target yield, and a second minimum yield all in association with a second vehicle maintenance taskset that pertains to a second vehicle;
invoking transistor-based circuitry configured to obtain a third maximum yield, a third primary target yield, and a third minimum yield all in association with a third vehicle maintenance taskset that pertains to both said first and second vehicles;
automatically invoking transistor-based circuitry configured to manifest said third primary target yield with a first preliminary allocation selectively among a first maintenance facility, said third vehicle maintenance taskset, and said first vehicle as a conditional response to a facility-to-taskset compatibility between said first maintenance facility and said third vehicle maintenance taskset and to a facility-to-vehicle compatibility between said first maintenance facility and said first vehicle;
automatically invoking transistor-based circuitry configured to manifest said third primary target yield again with a second preliminary allocation selectively among a second maintenance facility, said third vehicle maintenance taskset, and said second vehicle as a conditional response to a facility-to-vehicle compatibility between said second maintenance facility and said second vehicle and to a facility-to-taskset compatibility between said second maintenance facility and said third vehicle maintenance taskset;
automatically invoking transistor-based circuitry configured to manifest an other preliminary allocation selectively at least between said first maintenance facility and said first vehicle after said first and second preliminary allocations as a conditional response to said third vehicle maintenance taskset having a prioritization higher than a prioritization of said other preliminary allocation and to a taskset-to-taskset compatibility between said second vehicle maintenance taskset and said third vehicle maintenance taskset and to a facility-to-taskset compatibility between said first maintenance facility and said second vehicle maintenance taskset and to a facility-to-vehicle compatibility between said first maintenance facility and said first vehicle; and
transmitting a first expression of a first final schedule remotely to a first special-purpose device as a conditional response to a first Boolean determination signifying that two or more of said preliminary allocations collectively constitute said first final schedule.

5. The vehicle maintenance scheduling method of claim 4, wherein sad automatically invoking transistor-based circuitry configured to manifest said third primary target yield with said first preliminary allocation comprises:
automatically deciding which among said vehicle maintenance tasksets having a shared prioritization to allocate first as a conditional response to a difference of a degree of facility-to-vehicle compatibility among said vehicle maintenance tasksets having a shared prioritization.

6. The vehicle maintenance scheduling method of claim 4, wherein sad automatically invoking transistor-based circuitry configured to manifest said third primary target yield with said first preliminary allocation comprises:
automatically deciding which among said vehicle maintenance tasksets having a shared prioritization to allocate first as a conditional response to a difference of a degree of taskset-to-taskset compatibility among said vehicle maintenance tasksets having a shared prioritization.

7. The vehicle maintenance scheduling method of claim 4, wherein sad automatically invoking transistor-based circuitry configured to manifest said third primary target yield with said first preliminary allocation comprises:
automatically deciding which among said vehicle maintenance tasksets having a shared prioritization to allocate first as a conditional response to a difference of a degree of facility-to-taskset compatibility among said vehicle maintenance tasksets having a shared prioritization.

8. The vehicle maintenance scheduling method of claim 4, wherein said other preliminary allocation manifests said first primary target yield and selectively associates said first maintenance facility and said first vehicle both with said first vehicle maintenance taskset.

9. The vehicle maintenance scheduling method of claim 4, wherein said other preliminary allocation manifests said second primary target yield and selectively associates said first maintenance facility and said first vehicle both with said second vehicle maintenance taskset.

10. The vehicle maintenance scheduling method of claim 4, wherein said other preliminary allocation manifests a fourth primary target yield and selectively associates said first maintenance facility and said first vehicle both with a fourth vehicle maintenance taskset.

11. The vehicle maintenance scheduling method of claim 4, wherein said automatically invoking transistor-based circuitry configured to manifest said other preliminary allocation selectively at least between said first maintenance facility and said first vehicle after said first and second preliminary allocations as said conditional response comprises:
invoking said conditional response upon a determination that said first and second preliminary allocations have a shared prioritization higher than a prioritization of said other preliminary allocation.

12. The vehicle maintenance scheduling method of claim 4, wherein said automatically invoking transistor-based circuitry configured to manifest said other preliminary allocation selectively at least between said first maintenance facility and said first vehicle after said first and second preliminary allocations as said conditional response comprises:
determining that said second vehicle maintenance taskset has an intermediate prioritization relative to a higher and a lower prioritization, wherein said first vehicle maintenance taskset has said lower prioritization and said third vehicle maintenance taskset has said higher prioritization.

13. The vehicle maintenance scheduling method of claim 4, wherein said transmitting said first expression of said first final schedule remotely to said first special-purpose device comprises:
graphically presenting an allocation start time index, a taskset start time index, a taskset end time index, and an allocation end time index all as components of said first expression simultaneously manifested each as a transition between a lighter shade and a darker shade on a display screen of said first special-purpose device.

14. The vehicle maintenance scheduling method of claim 4, wherein said first special-purpose device is within said first maintenance facility.

15. The vehicle maintenance scheduling method of claim 4, further comprising:
obtaining a just-revised taskset list that contains said first, second, and third vehicle maintenance tasksets and also contains hundreds of additional vehicle maintenance tasksets that each pertains to one or more other vehicles and that each determines a respective maximum yield, a respective primary target yield, and a respective minimum yield;
processing a majority of said additional vehicle maintenance tasksets after said first expression of said first final schedule by manifesting a corresponding additional preliminary allocation selectively as a conditional response to a corresponding taskset-to-taskset compatibility and to a corresponding facility-to-taskset compatibility and to a corresponding facility-to-vehicle compatibility into a second final schedule; and
transmitting a first expression of said second final schedule remotely to said first special-purpose device as a real-time response to said obtaining said just-revised taskset list and as a conditional response to a second Boolean determination signifying that some of said corresponding additional preliminary allocations collectively constitute said second final schedule.

16. The vehicle maintenance scheduling method of claim 4, further comprising:
obtaining a just-revised taskset list that contains said first, second, and third vehicle maintenance tasksets and also contains hundreds of additional vehicle maintenance tasksets that each pertains to one or more other vehicles and that each determines a respective maximum yield, a respective primary target yield, and a respective minimum yield;
processing a majority of said additional vehicle maintenance tasksets after said first expression of said first final schedule by manifesting a corresponding additional preliminary allocation selectively as a conditional response to a corresponding taskset-to-taskset compatibility and to a corresponding facility-to-taskset compatibility and to a corresponding facility-to-vehicle compatibility into a second final schedule; and
transmitting a first expression of said second final schedule remotely to said first special-purpose device as a real-time response to said obtaining said just-revised taskset list and as a conditional response to a second Boolean determination signifying that some of said corresponding additional preliminary allocations collectively constitute said second final schedule, wherein said first expression of said second final schedule depicts at least ten successive projects spanning more than one year at said first maintenance facility.

17. A vehicle maintenance scheduling system comprising:
transistor-based circuitry configured to obtain a first maximum yield, a first primary target yield, and a first minimum yield all in association with a first vehicle maintenance taskset that pertains to a first vehicle;
transistor-based circuitry configured to obtain a second maximum yield, a second primary target yield, and a second minimum yield all in association with a second vehicle maintenance taskset that pertains to a second vehicle;
transistor-based circuitry configured to obtain a third maximum yield, a third primary target yield, and a third minimum yield all in association with a third vehicle maintenance taskset that pertains to both said first and second vehicles;
transistor-based circuitry configured to manifest said third primary target yield automatically with a first preliminary allocation selectively among a first maintenance facility, said third vehicle maintenance taskset, and said first vehicle as a conditional response to a facility-to-taskset compatibility between said first maintenance facility and said third vehicle maintenance taskset and to a facility-to-vehicle compatibility between said first maintenance facility and said first vehicle;
transistor-based circuitry configured to manifest said third primary target yield automatically again with a second preliminary allocation selectively among a second maintenance facility, said third vehicle maintenance taskset, and said second vehicle as a conditional response to a facility-to-vehicle compatibility between said second maintenance facility and said second vehicle and to a facility-to-taskset compatibility between said second maintenance facility and said third vehicle maintenance taskset;
transistor-based circuitry configured to manifest an other preliminary allocation selectively at least between said first maintenance facility and said first vehicle after said first and second preliminary allocations as a conditional response to said first and second preliminary allocations having a shared prioritization higher than a prioritization of said other preliminary allocation and to a taskset-to-taskset compatibility between said second vehicle maintenance taskset and said third vehicle maintenance taskset and to a facility-to-taskset compatibility between said first maintenance facility and said second vehicle maintenance taskset and to a facility-to-vehicle compatibility between said first maintenance facility and said first vehicle; and
transistor-based circuitry configured to transmit a first expression of a first final schedule remotely to a first special-purpose device as a conditional response to a first Boolean determination signifying that two or more of said preliminary allocations collectively constitute said first final schedule.
